(19) United States
(12) Patent Application Publication
(10) Pub. No.: US 2019/0051174 A1
(43) Pub. Date: Feb. 14, 2019

(54) TRAVEL PATH AND LOCATION PREDICTIONS

(71) Applicant: Lyft, Inc., San Francisco, CA (US)

(72) Inventors: Asif Haque, San Francisco, CA (US); James Kevin Murphy, San Francisco, CA (US); Yuanyuan Pao, Seattle, WA (US)

(73) Assignee: Lyft, Inc.

(21) Appl. No.: 15/675,422

(22) Filed: Aug. 11, 2017

(51) Int. Cl. G08G 1/123; G06Q 10/02; G06Q 50/30

(52) U.S. Cl. CPC G08G 1/123; G06Q 50/30; G06Q 10/025

(57) ABSTRACT

Embodiments provide techniques, including systems and methods, for determining projected locations for providers to better match providers in response to a transport request. Providers may be matched to a requestor based not only on a current location of the provider with respect to a request location, with a projected location of the provider that accounts for timing delays in processing transport requests, communication networks, etc. As such, projecting the projected location of the provider allows the dynamic transportation matching system to be matched more efficiently, reducing delay for the provider and requestor, and improving the efficiency of the system by preventing provider system resources from being taken from other service areas and decreasing provider inefficient rerouting upon matching.

### BACKGROUND

Traditionally, people have requested and received services at fixed locations from specific service providers. For example, various services were fulfilled by making a delivery to a user at a home or work location. Many services can now be accessed through mobile computing devices and fulfilled at arbitrary locations, often by service providers that are activated on demand. Such on-demand service offerings are convenient for users, who do not have to be at fixed locations to receive the services. However, matching a requestor and a provider can be difficult when both the requestor and the provider are moving. Additionally, locations provided by requestor computing devices and provider computing devices can be inaccurate and not represent a location where the requestor and the provider are to make an appropriate match to fulfill the on-demand service. Inaccurate and/or inefficient identification of locations of the providers related to on-demand service requests can lead to poor matching and inefficient resource allocation. For example, a provider's current location may be in close proximity to a requestor, but the provider may be driving in the opposite direction, so redirecting the provider may cause unnecessary delay if matched with a requestor. Another provider that may be further away but going in the direction of the requestor may be a better match and result in a faster pickup. This can lead to inefficient resource allocation as cancelled and duplicated requests increase bandwidth and processing needs, as well as disrupting efficient allocation of resources in a geographic area.

### BRIEF DESCRIPTION OF THE DRAWINGS

Various embodiments in accordance with the present disclosure will be described with reference to the drawings, in which:

FIG. 1 illustrates an example of a dynamic transportation matching system including a matched provider and requestor, in accordance with an embodiment of the present techniques;

FIG. 2 illustrates an example approach for determining current locations of providers in a geographic location to be utilized by a dynamic transportation matching system, in accordance with an embodiment of the present techniques;

FIG. 3 illustrates an example approach for determining projected locations of providers in a geographic location to be utilized by a dynamic transportation matching system, in accordance with an embodiment of the present techniques;

FIG. 4 illustrates an example approach for determining projected locations of providers in a geographic location to be utilized by a dynamic transportation matching system, in accordance with an embodiment of the present techniques;

FIG. 5 illustrates an example block diagram of a dynamic transportation matching system in accordance with embodiments of the present techniques;

FIG. 6 illustrates an exemplary flow diagram of a method for matching a provider with a requestor using a projected location of the provider, in accordance with an embodiment of the present techniques;

FIG. 7 illustrates an exemplary flow diagram of a method for determining projected locations of the providers, in accordance with an embodiment of the present techniques;

FIG. 8 illustrates an example requestor/provider management environment, in accordance with various embodiments;

FIG. 9 illustrates an example data collection and application management system, in accordance with various embodiments;

FIGS. 10A-10C illustrates an example provider communication device in accordance with various embodiments; and

FIG. 11 illustrates an example computer system, in accordance with various embodiments.

### SUMMARY OF THE INVENTION

According to embodiments of the present invention, a dynamic transportation matching system, in matching requestors (e.g., riders) and providers (e.g., drivers), can account for the constantly changing location of the provider's vehicle as a result of the movement of the vehicle by predicting a location of the provider vehicle in the short term future. The projected location of the provider vehicle can account for where the vehicle will be after a period of time, which can include for example, timing delays due to communications processing delays, the interaction and reaction time of coordinating multiple parties, driving delays and driving styles, and delays due to human decision making. Using a current location of a provider's vehicle may not result in the best possible match for a requestor because by the time the provider and requestor are matched, the provider may be in a different location or may have made a driving decision that affects the distance and/or time that it may take to reach a requestor. Thus, according to embodiments of the present invention, the transportation matching system can predict where the provider will travel to in a short period of time, such as during the timing delay, to more accurately match the requestor with the provider that will result in a more efficient and/or faster pick-up time to the requestor. Thus, embodiments determine a projected location of a vehicle in the near future to assist in dispatch and matching decisions which results in more efficient use of system processing resources by minimizing cancellations and duplicate requests as well as resulting in lower provider downtime and increased responsiveness to requests.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

On-demand services, such as a dynamic transportation matching service that matches requestors and providers, such as those accessed through mobile devices, are becoming more prevalent. However, due to the distributed and portable nature of providers and requestors being matched by an on-demand matching system, matching providers and requestors efficiently based on location data provided by electronic devices in sometimes challenging environments can be difficult. For example, delays can exist in transportation matching systems due to communications processing delays (e.g., the amount of time it takes for messages to be sent and processed by distributed computing systems), the interaction and reaction time of coordinating multiple parties (e.g., delay in accepting requests and updates to requestor positions), driving delays and driving styles (e.g., missed turns and other navigation errors), and delays due to human decision making (e.g., the time it takes for a provider to consider whether to accept a request or not). As such, a current location of a vehicle may not forecast the best possible match for a request due to future changes in direction or route that may affect the provider's ability to reach a requestor and/or their estimated arrival time to a request location. In an illustrative example, a provider may be approaching a split in a road that may affect whether they will be a good match for a request. If the system can predict which path the provider will take and use that projected location during matching, the system can more accurately and effectively match providers to requestors.

According to various embodiments, determining projected locations may include the use of kinematics based on current velocity and acceleration of the vehicle from GPS readings, and/or demand-based predictions using a Markov assumption that providers will move toward the most demand in a system, the least amount of traffic, and/or other beneficial situations in a region to a provider. Various embodiments may also use mapping information to map the projected location onto routes that are used to calculate estimated time of arrival (ETA) from the provider's current location or projected location to the requestor's location. The ETA may then be used to calculate a matching score for a provider. These projected locations may be used to foreclose travel paths that otherwise would appear to be available for a provider and increase the accuracy of the matching system based on the behavior and current speeds of the providers. Additional sensor data (e.g., gyroscopes, accelerometer, barometer measurements, etc.) collected from a vehicle or provider mobile device may further increase the accuracy of these projections. Further, behavioral information related to each provider may be analyzed to identify personalized driving style and personalized projections of future location. Similar methods may be used for matching passengers to autonomous vehicles based on requestor projected locations (i.e., predicting the location of a moving passenger for a ride request). Embodiments provide more accurate and efficient matching of providers and routing of vehicles to requests, leading to fewer canceled rides and minimized system processing requirements.

For example, matching a requestor with an optimal provider involves determining not only the current location of the provider, but the travel vector of the provider (e.g., provider's direction towards or away from the requestor location, provider driving on a correct one-way street, provider at an intersection, etc.). Inefficient determinations of a provider's current location and its predicted travel vector can create requestor downtime, as they may have to wait for the provider to turn around or go around a block, and in some cases can lead to cancellation of requests and re-booking of additional requests if the requestor determines their pickup request cannot be fulfilled within an acceptable amount of time. As the provider is part of an on-demand service, when a pickup request is cancelled, the provider may not be able to easily and efficiently provide their service to another requestor in their current location if they changed their direction for the canceled first request. Matching providers that are not going in the right direction towards the requestor can result in the provider making detours to get back in the direction towards the requestor. Particularly for multiple pickup requests chained in a route for a single provider, a pickup request that requires the provider to make a U-turn, for example, can result in delays for all the requestors as it propagates through the route. Requester wait time and inefficient utilization of a provider's travel time is problematic because it reduces ride system resources in an area and leads to lower utilization of the provider.

Accordingly, the difficulty in matching requests with providers using sub-optimal geographic-based location estimates leads to mismanagement of provider resources as well as increased system resources usage (e.g., data processing, bandwidth, and system communications). For instance, requestors may cancel a matched request where the provider is taking too long to arrive at the requestor or pickup location. Thus, requestors must place more requests in order to obtain a ride as one or more matched requests are canceled before the provider can locate and/or navigate to the requestor. Accordingly, more requests may be generated and processed by a matching service, more accepted, rejected, and declined requests must be processed by the requestor and provider devices, and more system resources must be expended for a matched ride to be successfully completed. Cascading requests and cancellations can lead to provider downtime, wasted travel time for the provider, and requestor wait time, as multiple providers accept the soon-to-be-cancelled transport requests in lieu of other requests. The cancelled providers may also grow frustrated with the cancellations and stop providing transport altogether in a particular area, leading to a lack to provider service in that area, potentially at a time of actual high demand.

Accordingly, the problem of inefficient travel paths in a computer-based dynamic transportation matching system leads to mismanagement of provider resources as well as at least increased data processing, bandwidth utilization, memory usage, and system communications as delay accumulates and cascading requests and cancellations are sent to a dynamic transportation matching system. Therefore, the techniques described herein improve the operation and efficiency of a transportation matching system, as well as the computing systems utilized as part of the transportation matching system infrastructure. By alleviating technical problems specific to dynamic transportation matching systems (e.g., inefficient dynamically-created pickup location predictions, cascading requests and cancellations (e.g., “button mashing”), etc.), the techniques described herein improve the computer-related technology of at least network-based dynamic transportation matching systems by increasing at least computational efficiency and computer resource allocation of at least the computer systems on which the techniques are performed.

At least one embodiment provides techniques, including systems and methods, for determining accurate and efficient projected locations where the provider may quickly, conveniently, and efficiently provide a service to a requestor at a point of service. In one embodiment, a set of instances of prior transport data of various types (e.g., prior request locations, prior actual pickup locations, prior current locations, prior transport destinations, prior travel paths, prior projected locations, prior actual travel paths, and/or prior actual drop-off locations) may be associated with a geographic location. For example, the dynamic transportation matching system may determine a likely location for a provider after a certain amount of time regardless of a request location (i.e., predicting where the provider will be in 5 seconds regardless of whether a request has been received or whether a match is currently processing). In another example, in a particular geographic region, there may be multiple requestor locations where requestors often make requests, and thus the system may determine different paths to reach the requestor locations from various current locations to generate a predictive model of how a provider can reach the requestor location, depending on its current location. These instances of transport data may cluster around common request locations. As more instances of prior transport data are generated around various geographical areas (e.g., home, work, frequented businesses, transit stops, etc.), a determination of which provider, based on its current location and projected location within that geographical area, to match to the requestor can be made, according to various embodiments. Other types of locations corresponding to various types of transport data may also be determined according to various embodiments, such as prior projected locations, modified target pickup locations, etc.

In an embodiment, a provider may not be in a location where the system has sufficient previously generated prior transport data that could be utilized as part of an approach to determine an appropriate projected location. In this case, the system may use a Markov model to assume that providers will naturally flow into the direction of pickup request demand. A Markov model is a stochastic model that may be used to model randomly changing systems where it is assumed that future states depend only on the current state, and not on the events that have occurred before it (e.g., prior transport data). Thus, a Markov model may be useful in making predictions where either there is insufficient prior transport data. For example, in a rural area that does not generate a lot of prior transport data or general traffic statistics, the system may not be able to predict the projected location of a provider easily based on historical traffic patterns, historical pickup request demands in that area, or historical behavior of the provider. According to an embodiment, if the provider's current location is associated with fewer than a threshold number of instances of prior transport data within the geographical area of the requestor location and the provider's current location, then a projected location may be based on current environmental data, such as road conditions, directions of the roads, current number of vehicles on the road, and/or other data that can be extrapolated from Global Positioning System (GPS) data or other location detection information. Examples of environmental data can also include, weather, road conditions, road directions, current traffic flow, a detected accident, a blocked road or lane, construction detours, a number of lanes on a road traveled by the provider, or a number of vehicles detected on the road traveled by the provider. Markov models may also be useful for situations where historical data (e.g., prior transport data) has shown to have little effect. For example, regardless of prior transport data, the dynamic transportation matching system may assume that available providers will navigate towards areas of high demand by requestors. Thus, based on a Markov model, the projected locations for providers may be presumed to be locations in the direction towards where the demand for transport is.

In contrast, in a business district of a metropolitan city, the dynamic transportation matching system may generate projected locations of providers within the geographic region covering the business district based on historical traffic patterns, maps of the business district (e.g., including one-way streets, rush-hour traffic rules, or bike lanes), historical pickup request demand and pickup request locations, and/or other prior transport data associated with the geographic region. For example, when there is a pending transport request from a requestor at 100 ABC Street, a potential provider may be located at an intersection a block east from 100 ABC Street. Depending on whether the potential provider turns cast (i.e., away from the requestor) or west (i.e., towards the requestor), the system may match the potential provider with the requestor to go towards the requestor location. The system may determine, based on prior transport data, a probability that the provider will turn east or west. For example, if turning east is towards a non-frequented area of the city and turning west is towards a busy downtown, then the probability that the provider will turn east may be lower compared to the probability that the provider will turn west towards the downtown. The probability may also be based on historical data, for example, out of 100 previous providers at that intersection at around the same time of day, 80 of them turned west and 20 of them turned east. In other embodiments, the probability may also be based on current and prior environmental data. For example, if the provider is at an intersection with a one-way street, then the probability that the provider will turn in a direction opposite of the one-way street is very low.

According to various embodiments, the dynamic transportation matching system may also factor in historical timing delays in matching times or reaction times as part of the prior transport data to determine projected locations. For example, depending on how quickly the dynamic matching system can match the potential provider to the requestor, it may make a match after the provider has already turned east (e.g., away from the requestor), which would then require the provider to make a U-turn or other detour to get back in the direction of the requestor location. However, if the intersection is at a traffic light that is timed, the dynamic matching system can attempt to match the provider and direct him towards the requestor location before the provider turns or moves in a different direction when the traffic light changes. Other environmental parameters may include weather, road conditions, road directions, current traffic flow, a detected accident, a blocked road or lane, construction detours, a number of lanes on a road traveled by the provider, or a number of vehicles detected on the road traveled by the provider, time of day, etc. These signals, including the amount and/or type of prior transport data, may be assigned varying weights in evaluations to determine one or more projected locations from a current location of a provider. However, the dynamic transportation matching system may not always find it necessary to determine projected locations for the potential providers in order to match a provider with a requestor. The dynamic transportation matching system can associate timing delays in determining matching scores or other techniques used to match a provider without projecting locations of the provider based on timing delays.

Additionally, one or more embodiments may use provider data, such as prior provider behavior and driving patterns, a lane position of the provider, kinematic information of the provider, or other data associated with the provider or provider vehicle to determine projected locations. For example, the lane position of the provider can provide valuable information on whether it is possible for the provider to turn or make an exit. The dynamic transportation matching system may predict that a provider in the right most lane as having a higher probability of exiting from the freeway than another provider in the left most lane, who likely would stay and continue straight on the freeway instead of changing multiple lanes to exit. Thus, the potential projected location to exit for the provider in the right lane may be assigned a higher probability than the provider in the left-most (i.e., fast) lane. In another example, kinematic information of the provider, such as a current speed and acceleration can be valuable in determining whether the provider can make a turn or exit. If the provider vehicle speed is 65 mph, it may not be likely that the vehicle will make a sharp turn in 25 feet to be directed towards a requestor location or exit the freeway at 65 mph, and the dynamic transportation system may assign a lower probability to that potential projected location.

Accordingly, embodiments filter potential projected locations for multiple providers that will increase the efficiency of the system and optimize the matching system's request matching processing to minimize the number of requests that will require system resources to process. Additionally, analyzing prior transport data related to request locations and current locations of providers in order to establish efficient pickup and/or drop-off locations results in more efficient processing of requests by the matching system, leading to fewer system resources necessary to handle a ride request load and an amount of requestor demand in an area. Accordingly, request matching systems are improved through the more efficient matching processing and fewer resources are required to process the same amount of requestor demand.

Although examples described herein generally focus on on-demand ride-sharing applications, any suitable service may be performed using similar functionality. For example, delivery of services may have a similar process implemented to find the location of delivery of the service. Additionally, a “provider” as discussed herein may include, for example, an automated dynamic transportation matching system that dispatches autonomous vehicles to respond to transport requests, an autonomous or otherwise computer-controlled vehicle (in whole or in part), or a human driver.

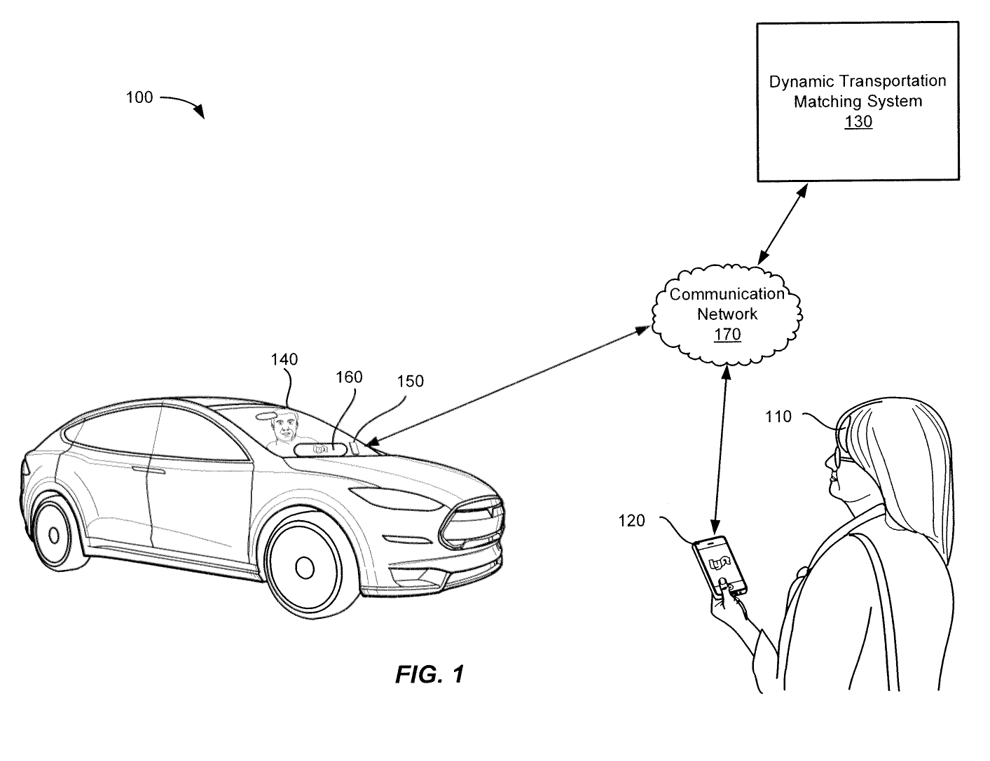

FIG. 1 illustrates an example of a dynamic transportation matching system 130 including a matched provider 140A and requestor 110A, in accordance with an embodiment of the present techniques. The dynamic transportation matching system 130 may be configured to communicate with both the requestor computing device 120 and the provider computing device 150. The provider computing device 150 may be configured to communicate with a provider communication device 160 that is configured to easily and efficiently display information to a provider 140 and/or a requestor 110. The requestor 110 may use a ride matching requestor application on a requestor computing device 120 to request a ride at a specified pick-up location. The request may be sent over a communication network 170 to the dynamic transportation matching system 130. The ride request may include transport request information that may include, for example, a request location, an identifier associated with the requestor and/or the requestor computing device, user information associated with the request, a location of the requestor computing device, a request time (e.g., a scheduled ride may have a future time for the request to be fulfilled or an “instant/current” time for transportation as soon as possible), and/or any other relevant information to matching transport requests with transport providers as described herein. The request location may include, for example, a current location of the requestor, a future location, a “best fit/predictive” location, a curb segment, or any other suitable information for indicating a location for a requestor to be found at the current time or in the future. In some embodiments, the transport request may further include other request related information including, for example, requestor transport preferences (e.g., highway vs. side-streets, temperature, music preference (link to 3^{rd} party music provider profile, etc.), personalized pattern/color to display on provider communication device, etc.) and requestor transport restrictions (e.g., pet friendly, child seat, wheelchair accessible, etc.).

The requestor computing device may be used to request services (e.g., a ride or transportation, a delivery, etc.) that may be provided by the provider 140A. The provider computing device may be used to contact available providers and match a request with an available provider based on a request location of the requestor and a current location of the available provider. However, both the requestor and provider may be moving at the time of the request and during a time lag for communications in processing the request. As a result, matching the appropriate provider for the request can be challenging with constantly changing request locations of the requestor and current locations of the provider. For example, the provider may make a decision (e.g., turning the opposite direction, taking an exit off a freeway, etc.) that impacts the amount of time it may take to reach a request location. The system may not be aware of such a turn (until the next current position information is received) and may believe that the provider would be a good match for a request. As such, the system may prioritize the provider over other providers in the area that may actually be better matches now that the provider has made the decision that negatively impacts the match.

The dynamic transportation matching system (also referred to as a “ride matching system”) 130 may identify available providers that are registered with the dynamic transportation matching system 130 through an application on their provider communication device 150A. The dynamic transportation matching system 130 may send the ride request to a provider communication device 150A and the provider 140A may accept the ride request through the provider communication device 150A. Additionally and/or alternatively, in some embodiments, the provider may be predictively and/or automatically matched with a request such that the provider may not explicitly accept the request. For instance, the provider may enter a mode where the provider agrees to accept all requests that are sent to the provider without the ability to decline and/or review requests before accepting. In either case, the provider computing device may return information indicative of a match indicating that the provider received the transport request. For example, the information indicative of a match may include a provider accept indicator (e.g., a flag) that indicates the provider received and accepts the indicator or could include a variety of different information. For example, the information indicative of a match may include location information, other route information for other passengers in the vehicle, a schedule for the provider providing information regarding future availability (e.g., when they are going to go offline), diagnostics associated with the car (e.g., gas level, battery level, engine status, etc.), and/or any other suitable information. The provider 140A and the requestor 110A may be matched and both parties may receive match information associated with the other respective party including requestor information (e.g., name, representative symbol or graphic, social media profile, etc.), provider information (e.g., name, representative symbol or graphic, etc.), request location, destination location, respective computing device location, rating, past ride history, any of the other transport request information and/or provider acceptance information identified above, and/or any other relevant information for facilitating the match and/or service being provided. Thus, the dynamic transportation matching system 130 may dynamically match requestors and providers that are distributed throughout a geographic area.

In some embodiments, an available provider or a set of potential providers may be determined based on their current locations being within a predetermined radius around the request location or a distance threshold from the request location. For example, a set of potential providers may be determined by selecting providers that are within 5 miles of the request location, and the provider selected to match with the requestor may be provider that is closest to the request location (e.g., 0.5 miles). In another embodiment, the set of potential providers may be determined by a time to travel threshold. For example, a potential provider may be only 3 miles away from the request location, but in heavy traffic, so it may take 15 minutes to travel to the request location. Another potential provider may be on a different road and is 5 miles away but the time to travel to the request location is 7 minutes. Thus, the provider that is further away but can arrive more quickly may be matched with the request. However, the current location of a provider may not be accurate or easily determined, particularly when the provider is moving. In various embodiments, more than location data of the provider may be used to appropriately and efficiently match providers with requests, and the dynamic transportation matching system may also use a direction of the provider. For example, a provider may be approaching an intersection in a road that may affect whether they will be a good match for a request. Thus, embodiments provide a solution that can predict a projected location the provider will take and use that projected location to more accurately and effectively match providers to requestors. According to various embodiments, determining projected locations may include the use of kinematics based on current velocity and acceleration of the vehicle from GPS readings, and/or demand-based predictions using a Markov assumption that providers will move toward the most demand in a system. Thus, embodiments provide a solution that allows a dynamic transportation matching system to projected locations of potential providers to ensure the most efficient matching resulting in reduced requestor wait time and provider travel time, as well as increased throughput by the dynamic transportation matching system.

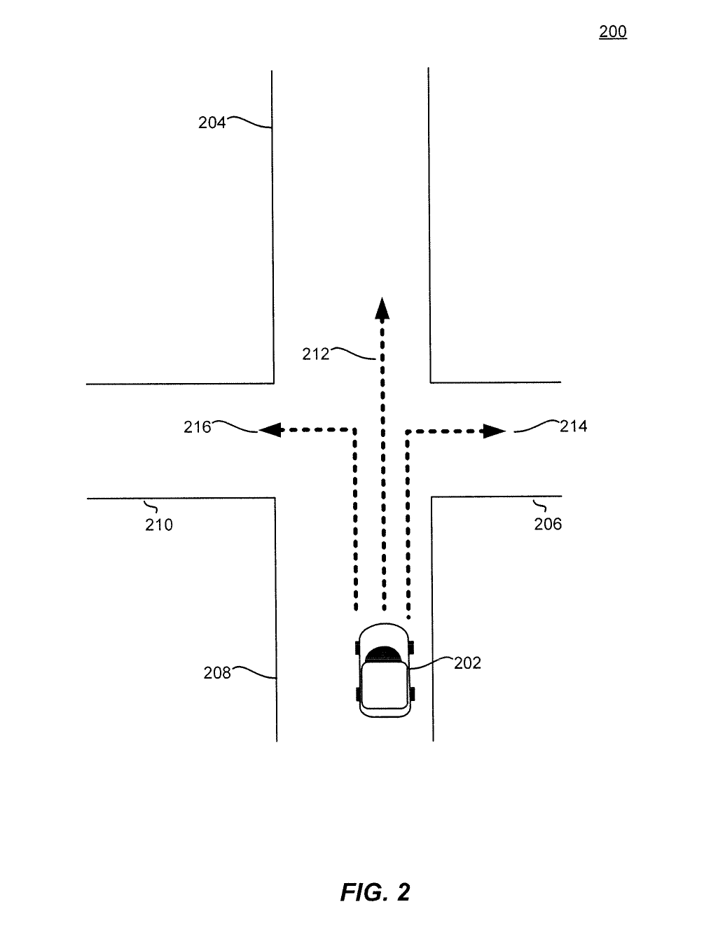

FIG. 2 illustrates an example approach for determining projected locations of a provider by a dynamic transportation matching system, in accordance with an embodiment of the present techniques. In the example 200 of FIG. 2, provider 202 may be stopped at an intersection at a southbound portion 208 of the intersection with an eastbound road 206, a northbound road 204, and a westbound road 210. The dynamic transportation system may first determine a current location of the provider vehicle 202, and in this example, determine that it is at the southbound portion 208 of the intersection. The current location of the provider vehicle 202 may be reported by a GPS module on the provider's computing device, for example. Based on mapping data from GPS or other mapping databases, the dynamic transportation matching system may determine that there are three potential projected locations 212, 214, and 216. For example, projected location 214 represents the projected location of the provider vehicle as turning right to travel down the eastbound road 206. Projected location 212 represents the projected location of the provider vehicle 202 traveling straight through the intersection to the northbound road 204 of the intersection. Projected location 216 represents the projected location of the provider vehicle 202 turning left to travel down the westbound road 210 of the intersection. The projected location or projected location indicates a position or direction in which after a period of time, in the future, the provider vehicle 202 is predicted to be in. The time period may be a matter of seconds and may be determined based on time delays associated with communications between the requestor computing device, provider computing device, and the dynamic transportation matching system. Other delays can include delays in human decision making, human error, GPS location delays, etc.

According to an embodiment, each projected location 212, 214, and 216 may be assigned a confidence score, indicating a level of confidence that the projected location will be the actual travel path that the provider vehicle 202 actually takes. The confidence score can be a quantitative measurement of a reliability of the probability the vehicle will travel to the projected location, indicating to the dynamic transportation matching system that the projected location is trustworthy and can be relied upon for matching providers and requestors. The confidence score may be determined based on multiple parameters, including environmental data, behavioral data of the provider, kinematic data of the provider vehicles (e.g., speed, acceleration), position of the provider vehicle in the road (e.g., which lane), and/or a statistical probability for each travel path. Other parameters considered in determining a confidence score can include historical travel paths from the current locations, directional information, timing delay to and from the requestor computing device, timing delay to and from the provider computing device, movement of the requestor, and historical data associated with the one or more providers. The statistical probability of each projected location may be calculated based on prior transport data associated with the intersection in 200. For example, historical traffic patterns and other data may indicate that at that intersection 80% of cars at location 208 turn right to travel down the eastbound road 206, which would increase the probability for projected location 214. In an embodiment, prior transport data may be stored and associated with any number of alternate or additional criteria. For example, prior transport data may be associated with times of prior transport requests (e.g., requests, pickups, drop-offs, etc.), weather data, event data (e.g., that may be time- or geographically-related and acquired in an embodiment by receiving data from a data store, such as in a response to an application programming interface (APT) request), traffic density data (e.g., that may be used as part of a determination regarding contextual activities; for example, a request made at a location at a particular time, along with traffic density being low, may indicate a context that the roads may be clear to make a U-turn, etc., while a request at a busy street corner during rush hour may indicate a context that there will be rush hour traffic, congestion after a music or entertainment event, etc.). Other examples of prior transport data can include social media, event, and/or contact data associated with a person's computing device may also be used, such as to determine contextual activities, prior requestor behavior, prior provider behavior, etc. Different weights may be assigned to different parameters of prior transport data to determine probabilities of whether a provider from a current location will travel to a projected location. The probabilities of each projected location may then be converted to a confidence score for each projected location that can be easily compared to the confidence scores of other projected locations for the same provider or the confidence scores of the projected locations of other providers.

In an embodiment, other factors may be used in generating, increasing, decreasing, etc. of various weighting values assigned to instances of prior transport data. For example, weather data may be used. When a request is received on a rainy day, it may be relevant that certain actual pickup locations were used on previous rainy days; for example, by a door with a short distance to a convenient parking spot. Time data may also be used. For example, many people may be congregating outside a building at 5 PM. Prior pickups at this time may have been further down the street that may otherwise be efficient, to avoid the crowds of people and vehicles. Various other data may also be used in the determination of target pickup locations (and in some embodiments, drop-off locations), such as destinations, road data (e.g., construction, traffic, etc.), safety data (e.g., pedestrian accident data), budget for a particular transport request, such as over time or on a particular day, ratings associated with particular providers, etc.

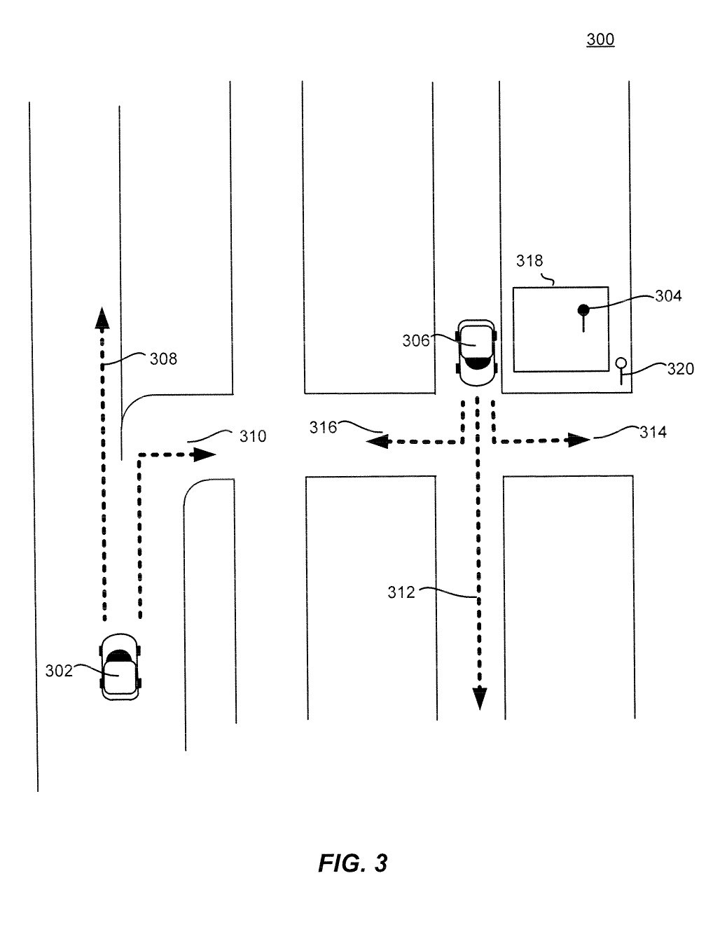

FIG. 3 illustrates an example approach for predicting travel paths of providers by a dynamic transportation matching system, in accordance with an embodiment of the present techniques. In the example 300 of FIG. 3, a requestor may indicate a request location pin at 304. The dynamic transportation matching system may determine a set of potential providers that are within a geographic region of the request location 304, for example by determining available providers within a distance threshold or radius. In example 300, two providers may be identified as potential providers 306 and 302, and their respective current locations may be ascertained. Provider 302 is shown to have a current location on a freeway by an exit, and provider 306 is shown to have a current location on the same block as request location 304.

In conventional approaches using current location alone, because provider vehicle 306 is on the same block as the request location pin 304, provider vehicle 306 may be matched to fulfill the request over provider vehicle 302. However, using current location alone can be insufficient because as the requestor's request is being processed and/or as provider vehicle 306 is being matched, the provider vehicle 306 may actually be turning right—in other words, turning away from the request location 304 and in the opposite direction. As a result, if provider vehicle 306 was matched and the provider computing device receives a notification of the match after the turn was made, then the provider vehicle 306 would then need to either make a U-turn or go around the block to reach the request location 304. This would result in a delay in reaching the request location 304, which increases wait time for the requestor, wastes driving time and resources for the provider vehicle 306, and overall reduces efficiency and provider resource allocation across the entire dynamic transportation matching system. Further, if provider 302 were matched to the request instead of provider 306, these delays could have been avoided.

According to various embodiments, however, the dynamic transportation matching system uses current locations of the providers and determines a projected location of each potential provider to make an appropriate and optimal match to the requestor. In example 300, the dynamic transportation matching system may determine the following projected locations for provider vehicle 306: projected location 314 by driving left towards the requestor location 304, projected location 312 by driving straight through the intersection, and projected location 316 by driving right, away from the requestor location 304. For provider vehicle 302 traveling on a freeway, there may be two projected locations determined: projected location 308 by continuing on the freeway, and projected location 310 by exiting from the freeway on the right towards the request location 304. In some embodiments, as discussed above with respect to FIG. 2, confidence scores of each of the projected locations may be determined based on statistical probabilities for each projected location. The probabilities for each projected location may be calculated based on historical traffic patterns in the geographic region. For example, historical traffic patterns may indicate that the freeway exit is a popular exit where 75% of vehicles traveling in the right lane of the freeway will make the exit. Accordingly, the dynamic transportation matching system may then calculate that the probability that provider vehicle 302 will travel to projected location 310, and projected location 310 may have a better confidence score than projected location 308. For provider vehicle 306, historical traffic patterns may indicate that only 10% of vehicles at the same position in the intersection as provider vehicle 306 turn left, thus the probability that vehicle provider 306 may travel to projected location 314 is relatively low and the confidence score for projected location 314 will indicate a low confidence. As such, a confidence score for provider 302 taking projected location 310 may be higher than the confidence score of provider 306 taking path 314. Accordingly, using projected locations based on a confidence score using probabilities calculated from historical data allow the dynamic transportation matching system to intelligently match provider vehicle 302 to fulfill the request at request location 304 despite provide vehicle 306 being at a current location that is closer.

In another embodiment, in addition or alternative to probabilities based on historical traffic patterns, the dynamic transportation matching system may use prior transport data to determine a confidence score for each projected location for each potential provider. Prior transport data may include, among other parameters, prior requestor behavior, prior provider behavior, prior request locations, prior pickup locations, prior destinations, weather data, prior request demand, or prior events or times that affect request demand (e.g., rush hour times or congestion after a music concert).

In some embodiment, behavioral information related to each provider may be analyzed to identify personalized driving style and personalized projections of future location. In example 300, there may be prior provider behavior associated with provider vehicle 306, indicating that the provider prefers to only drive on local roads and not freeways; thus despite historical traffic patterns having a higher probability of more vehicles traveling to projected location 316, the provider operating provider vehicle 306 may be more inclined to travel to projected location 314 to stay on local roads. In another example, if request location 304 is at a bar and the request time is at 3 am, the provider operating provider vehicle 302 may prefer to not pick up customers from specific locations after certain hours, so despite historical traffic patterns having a higher probability of more vehicles traveling towards projected location 310 to exit the freeway, the provider operating provider vehicle 302 may continue on the freeway towards projected location 308. In another example, prior provider behavioral data may show that the provider turns east at a particular location 70% of the time, which can be included in the determination of what the provider's projected location is the next time they are at that particular location. Prior transport data may also indicate to the dynamic transportation matching system that from prior requests from the same request location 304, it was more efficient to have providers from the freeway exit to reach the request location 304 than to have providers on local roads make U-turns or navigate around the local roads to reach request location 304. As such, according to various embodiments, prior transport data, such as prior requests and/or prior provider behavior, can provide more accurate confidence scores for the projected locations.

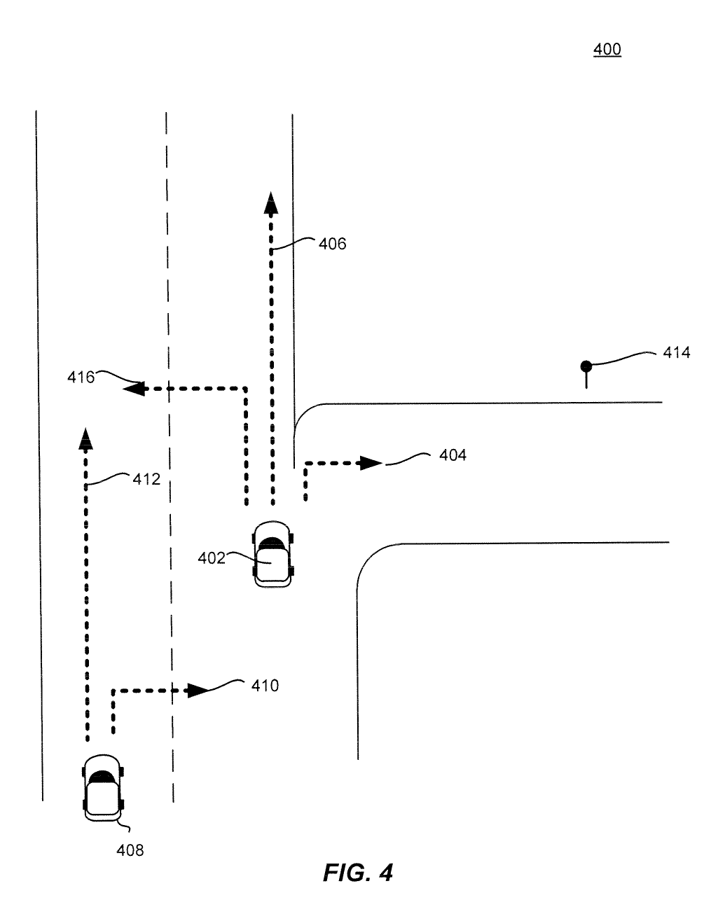

FIG. 4 illustrates an example approach for determining projected locations for providers by a dynamic transportation matching system, in accordance with an embodiment of the present techniques. In the example 400 of FIG. 4, for request location 414, the dynamic transportation matching system may identify provider 402 and provider 408 as potential available providers to match and fulfill the transport request. For each provider, projected locations may be determined. For each projected location, the dynamic transportation matching system may factor, in addition to or alternative to environmental data, probabilities and prior transport data as discussed above, current kinematic data associated with the provider vehicle may also be factored into the confidence score determination. Kinematic data may include, but is not limited to, the speed of the provider vehicle, the acceleration, lane position, etc. For example, for provider vehicle 402, the dynamic transportation matching system may determine projected location 404 by exiting the freeway, projected location 406 by staying in the right lane on the freeway, or projected location 416 by changing lanes and stay on the freeway. For provider vehicle 408, its projected locations may include projected location 412 by continuing in the leftmost lane on the freeway, or projected location 410 by changing to a right lane on the freeway. Kinematic data may be transmitted by the provider vehicle or the provider computing device.

A confidence score may be determined for each one of these projected locations based on kinematic data of provider vehicle 402 and provider vehicle 408, according to various embodiments. For example, if provider vehicle 402 is traveling at a speed of 65 mph and is determined to be accelerating, then it may not be likely that the provider would exit to projected location 404 because it may not be possible or safe to have provider vehicle 402 to exit that quickly at that speed and acceleration. As such, projected location 404 may have a lower confidence score than projected location 406 or 416. The kinematic data of provider vehicle 408 may indicate that, given its position that it is further away from the exit and its current speed and acceleration, the provider vehicle 408 may be more likely to able to safely change lanes to the right in order to exit and fulfill the request. As such, the probability the provider vehicle 408 will travel to projected location 412 may be relatively likely at the provider vehicle's 408 current speed to continue in the same lane on the freeway, resulting in a relatively good confidence score for projected location 412. However, the confidence score may be even higher for projected location 410 because there is a greater probability that provider vehicle 408 will change lanes to projected location 410, based on kinematic data, for example, a change in speed and slight change in the position of provider vehicle 408 in the lane. The confidence score can be a quantitative measurement of a reliability of the probability the vehicle will travel to the projected location, indicating to the dynamic transportation matching system that the projected location is trustworthy and can be relied upon for matching providers and requestors. Subsequently, when the projected locations are determined to have confidence scores above a threshold, the dynamic transportation system may then calculate ETAs from the projected locations to the request location. The corresponding ETAs for each projected location for each provider are then used to determine the best match to fulfill the request. For example, a faster ETA from projected location 410 would indicate that provider vehicle 408 would be the best match. In some embodiments, the ETAs would be used to calculate a matching score, and the provider selected to fulfill the request may be based on each provider's matching score. In this example, the provider vehicle 408 may be selected to fulfill the request, as the provider in provider vehicle 408 can more safely and efficiently fulfill the request with a higher probability of success because project location 410 would result in a faster ETA to the request location. Although in this example there are two provider vehicles, embodiments of the invention may be applied to any number of potential provider vehicles, each provider vehicle having any number of projected locations. Other parameters that may be considered in determining a confidence score can include historical projected locations from the current locations, directional information, timing delay to and from the requestor computing device, timing delay to and from the provider computing device, movement of the requestor, and historical data associated with the providers.

In an embodiment, a matching score may be determined as well in order to select a provider best suited for the transport request. A matching score may be determined based on an ETA to the request location, the requestor's parameters (e.g., number of passengers, trunk space for luggage, child car seat, etc.) or provider's parameters (e.g., type of car), ratings for both the requestor and/or the provider, or demand. The matching score may include multiple factors or parameters that are weighted. In some embodiments the matching score is separate from the confidence score and may be given different weights to ultimately determine which provider to select for matching with the request. The confidence score may be used as an indicator of whether a potential projected location is accurate and whether the dynamic transportation system should rely on that projected location, or how much weight the dynamic transportation system should give to the projected location. As such, the confidence score may be used to filter projected locations of provider vehicles, where each projected location is associated with a probability of how likely the provider vehicle will travel to that projected location. The confidence score can be a quantitative measurement of a reliability of the probability the vehicle will travel to the projected location, indicating to the dynamic transportation matching system that the projected location is trustworthy.

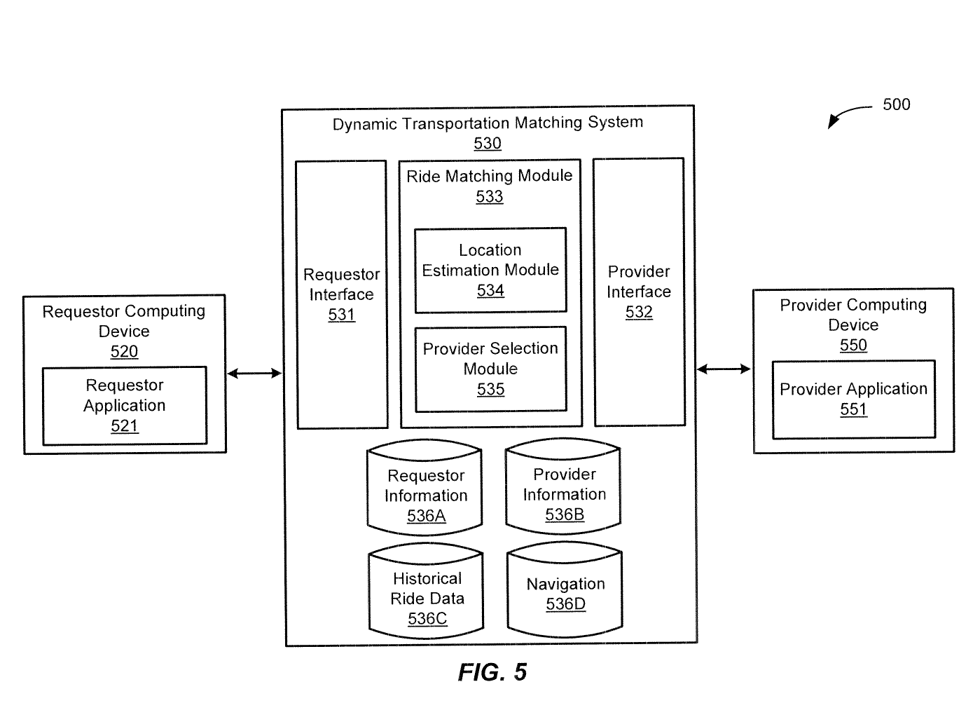

FIG. 5 illustrates an example block diagram 500 of a dynamic transportation matching system 530, in accordance with an embodiment of the present techniques. As described above, the dynamic transportation matching system 530 may identify and facilitate request matching from requestors associated with requestor computing devices 520 with available providers 140 associated with provider computing devices 150. The dynamic transportation matching system 530 may include a requestor interface 531, a provider interface 532, and a ride matching module 533 including a projected location module 534, and a provider selection module 535. The dynamic transportation matching system 530 may also include a requestor information data store 536A, a provider information data store 536B, a historical ride data store 536C, and a navigation data store 536D which may be used by any of the modules of the dynamic transportation matching system 530 to obtain information in order to perform the functionality of the corresponding module. The dynamic transportation matching system 530 may be configured to communicate with a plurality of requestor computing devices 520 and a plurality of provider computing devices 550. Although the dynamic transportation matching system 530 is shown in a single system, the dynamic transportation matching system 530 may be hosted on multiple server computers and/or distributed across multiple systems. Additionally, the modules may be performed by any number of different computers and/or systems. Thus, the modules may be separated into multiple services and/or over multiple different systems to perform the functionality described herein.

Although embodiments may be described in reference to ride requests, any number of different services may be provided through similar request and matching functionality. Accordingly, embodiments are not limited to the matching of ride requests and one of ordinary skill would recognize that embodiments could be implemented for any number of different services that have requestors and providers being matched through a network of connected computing devices.

The requestor interface 531 may include any software and/or hardware components configured to send and receive communications and/or other information between the dynamic transportation matching system 530 and a plurality of requestor computing devices 520. The requestor interface 531 may be configured to facilitate communication between the dynamic transportation matching system 530 and the requestor application 521 operating on each of a plurality of requestor computing devices 520. The requestor interface 531 may be configured to periodically receive ride requests, location information, a request location (also referred to as a “pick-up” location, although in some embodiments, a request location and an actual or target pick-up location are different events), requestor status information, a location of the requestor computing device, progress toward a request location by the requestor computing device, and/or any other relevant information from the requestor computing device 520 when the requestor application 521 is active on the requestor computing device 520. The ride request may include a requestor identifier, location information for the requestor computing device 520, a pick-up location for the ride request, one or more destination locations, a pick-up time, and/or any other suitable information associated with providing a service to a requestor. The ride request may be sent in a single message or may include a series of messages. The ride matching module 533 may receive the ride request and update a historical ride data store 536C with the ride request information, including types of instances of prior transport data (e.g., prior request locations, prior actual pickup locations, prior transport start locations, prior transport destinations, and/or prior actual drop-off locations, etc.).

Additionally, the requestor interface 531 may be configured to send ride match messages, location information for the provider computing device, provider information, travel routes, pick-up estimates, traffic information, requestor updates/notifications, and/or any other relevant information to the requestor application 521 of the requestor computing device 520. The requestor interface 531 may update a requestor information data store 536A with requestor information received and/or sent to the requestor, a status of the requestor, a requestor computing device location, and/or any other relevant reformation, such as locations of instances of prior transport data as described above.

A requestor computing device 520 may include any device that is configured to communicate with a dynamic transportation matching system 530 and/or provider computing device 550 over one or more communication networks. The requestor computing device 520 may comprise a processor, a computer-readable memory, and communication hardware and/or software to allow the requestor computing device 520 to communicate over one or more communication networks. For example, a requestor computing device 520 may include a mobile phone, a tablet, a smart watch, a laptop computer, a desktop computer, and/or any other suitable device having a processor, memory, and communication hardware In some embodiments, the requestor computing device 520 may include a requester application 521 that is configured to manage communications with the dynamic transportation matching system 530 and interface with the user (i.e., requestor) of the requestor computing device 520. The requestor application 521 may allow a user to request a ride, monitor the status of a matched ride, pay for a ride, monitor past rides, perform any other requestor-oriented services related to the dynamic transportation matching system 530, and/or obtain any other requestor-oriented information from the dynamic transportation matching system 530.

The provider interface 532 may include any software and/or hardware configured to send and receive communications and/or other information between the dynamic transportation matching system 530 and a plurality of provider computing devices 550. The provider interface 532 may be configured to periodically receive location information of the provider computing device 550, provider status information, and/or any other relevant information from the provider computing device 550 when the provider application 551 is active on the provider computing device 550. Additionally, the provider interface 532 may be configured to send ride requests, location information of a requestor computing device 520, pick-up locations, travel routes, pick-up estimates, traffic information, provider updates/notifications, and/or any other relevant information to the provider application 551 of the provider computing device 550. The provider interface 532 may update a provider information data store 536B with provider information received and/or sent to the provider, a status of the provider, a provider computing device location, and/or any other relevant information, including locations of instances of prior transport data as described above.

A provider computing device 550 may include any computing device that is configured to communicate with a dynamic transportation matching system 530 and/or provider computing device 550 over one or more communication networks. The provider computing device 550 may comprise a processor, a computer-readable memory, and communication hardware and/or software to allow the provider computing device 150 to communicate over one or more communication networks. For example, a provider computing device 550 may include a mobile phone, a tablet, a smart watch, a laptop computer, a desktop computer, and/or any other suitable device having a processor, memory, and communication hardware. In some embodiments, the provider computing device 550 may include a provider application 551 that is configured to manage communications with the dynamic transportation matching system 530 and interface with the user of the provider computing device 550. The provider application 551 may allow a user to accept a ride request, monitor the status of a matched ride, obtain or generate navigation directions or a mapped route for a matched ride, get paid for a ride, monitor past rides, perform any other provider-oriented services related to the dynamic transportation matching system 530, and/or obtain any other provider-oriented information from the dynamic transportation matching system 530.

The ride matching module 533 may include a software module that is configured to process ride requests, ride responses, and other communications between requestors and providers of the dynamic transportation matching system 530 to match a requestor and a provider for a requested service. For example, the ride matching module 533 may be configured to identify available providers for a ride request from a requestor by identifying a geographic region associated with the pick-up location and may search a provider information data store 536B to identify available providers within a predetermined distance of the pick-up location and/or the geographic region.

The ride matching module 533 may include a projected location module 534 and a provider selection module 535 that are configured to allow the ride matching module to perform efficient matching at target pickup/destination locations using the techniques described herein. For example, when the ride matching module 533 receives the request, the ride matching module 533 may identify available providers in the geographic area around the request location. The ride matching module 533 may use a threshold distance (e.g., 10 miles, 15 miles, etc.), one or more zip codes or other geographic identifiers (e.g., streets, blocks, neighborhoods, city, region, etc.), or any other suitable geographic limitation to identify available providers relevant to a request location. For example, the ride matching module 533 may search the provider information data store 536B to identify any available providers that are located within a certain distance from the request location or have a threshold estimated time of arrival (ETA) to the request location and/or a destination location associated with the request. The ride matching module 533 may also limit the search for available providers to those that meet ride request criteria such that the available provider can serve the request. For example, whether a provider vehicle is a sedan, luxury, SUV, or other type of car, has a particular type of feature or amenity (e.g., car seat, dog friendly, etc.), has a number of available seats (e.g., request for 2 people, etc.), and/or may use any other stored information at the dynamic transportation matching system to limit available providers to those that can serve the request.

Once the ride matching module 533 identifies the available providers in the area, the ride matching module 533 may calculate an estimated travel time for each of the providers from their current location to the request location. As discussed above, the ride matching module 533 may incorporate traffic, weather, road closures, and/or any other conditions that may affect travel time into the estimation. The ride matching module 533 may use historical ride data that is relevant for the time of day, streets and geographic region, as well as stored previous rides over those times, areas, road conditions, and/or any other information to obtain an estimate for the provider to travel from their current location to the request location. For example, the ride matching module 533 may be configured to obtain the location of each of the provider computing devices. The ride matching module 533 may be configured to identify the request location and map navigation routes for each of the providers and the requestor to the request location. The ride matching module 533 may calculate an estimated time of arrival for a variety of different routes based on navigation information obtained from a navigation data store 536D. The navigation information may include real-time and historical traffic information, historical travel time information, known routes for a geographic area or region, traffic rules, and/or any other suitable information for mapping and/or identifying potential routes for traveling from one location to another based on a type of transportation (e.g., driving, biking, sailing, flying, etc.). The ride matching module 533 may map a plurality of possible routes from the provider location to the request location as well as the alternate request locations and generate an estimated arrival time for each of the potential mapped routes. The ride matching module 533 may select the fastest route and/or the most probable route for each of the providers and the corresponding estimated travel time for that route as the estimated travel time for the provider. The ride matching module 533 may incorporate current traffic conditions, road closures, weather conditions, and any other relevant travel time related information to calculate an estimated arrival time for the provider. The estimated arrival time may also be calculated by taking an average of the arrival time of each of the mapped routes, selecting the estimated arrival time for the fastest route, receiving a selection of one of the potential routes by the provider, identifying the route being taken based on the route being used by the provider, and/or through any other suitable method. If the provider makes a wrong turn and/or follows a different route than that calculated by the ride matching module 533, the ride matching module 533 may obtain the updated location of the provider computing device and recalculate the possible routes and estimated arrival times. As such, the estimated travel times may be updated as travel and road conditions, weather, etc. are updated. Accordingly, the ride matching module 533 may determine a navigation route associated with the request location and an estimated travel time for each of the providers. Further, the estimated time may be determined through any suitable method including taking an average of multiple routes, selecting the fastest route, adding additional cushion time when certainty is low for the estimate of the time, etc. Accordingly, the ride matching module 533 may determine an estimated travel time for each of the available providers in the area that may potentially match the request.

The projected location module 534 may use current locations of providers to determine projected locations based on probabilities of the providers traveling from their current locations to the projected locations and the respective confidence scores for each projected location. For example, the projected location module may perform clustering of instances of prior transport data and associate the clusters with various locations and/or geographic areas, such as may be obtained from navigation data store 536D or requestor information 536A. The projected location module 534 may use the instances of prior transport data to project a location of the provider vehicle based on prior provider behavior, prior requests, prior transport routes, etc. As discussed herein, to determine projected locations for each provider, the dynamic transportation matching system may access historical ride data in data store 536V, provider information 538B, navigation information 536D, and requestor information 536A to calculate a confidence score for each projected location based at least on environmental data, probabilities, prior transport data, and/or kinematic information. The projected location module may perform some or all of the techniques described herein to project at least one projected location for each provider identified as a potential provider. The projected locations and their confidence scores are then used by the ride matching module 533 to calculate ETAs from the projected locations to the request location. The ETA can vary and be dependent on the projected location of the provider vehicle, i.e., where the dynamic transportation matching system thinks the provider vehicle is going to be in the future. The projected location and its associated ETA may then be used to determine whether to match the provider to the request. Initially, an ETA may first be based on the current location of the provider vehicle, but when projected locations are determined for the provider vehicle, updated ETAs may be calculated based on the projected locations. Selecting the provider may be based on the provider with the projected location associated with the fastest ETA with a confidence score for the projected location that satisfies a threshold as being trustworthy to the dynamic transportation matching system.

The ride matching module 533 may then provide estimated travel times for the providers and the requestor to the provider selection module 535. The provider selection module 535 may obtain the estimated travel times and may select one or more providers that should be matched with the request. Accordingly, the provider selection module 535 may generate a dynamic provider eligibility model that incorporates both the estimated requestor arrival time and the estimated provider times of each of the providers to identify those available providers that are eligible for a match. The provider selection module 535 may then select a subset of the eligible available providers and select one of the providers based on a matching score. The matching score may be based at least on system efficiency, rankings, route, arrival time, and/or any other suitable information that can be used for matching. For example, two available providers may be identified as eligible for a request because they both may have projected locations with good confidence scores, which accounts for a projected location that causes less driving, fewer turns, safer driving, and all the other benefits of allowing providers to maintain their current direction of travel. The provider selection module 535 may select the provider that has a better matching score based on a faster ETA from the projected location to the request location. In another example, a requestor may only wish to be paired with requestors with a rating above a threshold, so even a provider with a lower rating will have a lower matching score and not be matched even if it has a projected location that is confident and towards the requestor.

Additionally, in some embodiments, the provider selection module 535 may perform available provider prediction to ensure that the best possible match is being made. For instance, the provider selection module 535 may obtain an available provider rate associated with the request location from a historical ride data store 536C that may indicate the historical rate of available providers coming online near the request location. Additionally and/or alternatively, the ride history data store 536C may be consulted for existing rides that have providers that will be dropping off requestors in the area before the requestor arrival time is up. For instance, if a request is received for a busy area where a number of different providers with requestors are dropping off previously matched requestors and/or where new providers are known to become active during the time frame of the requestor arrival time, the provider selection module 535 may delay matching to see if a provider becomes available in the area that is closer than the existing eligible providers for the request. Accordingly, by tracking and monitoring system activity as well as using estimated arrival times for the providers and requestor over time, the system can more efficiently and effectively match provider resources with requestor resources to ensure the most efficient matching of resources.

The ride matching module 533 may provide the ride request to the provider interface 532 with the provider contact information or provider identifier so that the ride request may be sent to one or more available providers. The ride matching module 533 may send the ride request and/or the information from the ride request to one or more of the selected available providers to determine whether the available providers are interested in accepting the ride request. The one or more available providers may receive the ride request through the provider application 551 of the provider computing device 550, may evaluate the request, and may accept or deny the request by providing an input through the provider application 551. A ride response message may be sent to the dynamic transportation matching system 530 indicating whether a ride was accepted and including a provider identifier, a location of the provider, and/or any other suitable information to allow the dynamic transportation matching system 530 to process the response. Alternatively, the provider may ignore the request and after a predetermined period of time, the request may be considered denied and a corresponding ride response message may be sent to the dynamic transportation matching system 530. In some embodiments, no response may be sent unless a ride request is accepted and the ride will be assumed to be denied unless a response is received from the provider. In other embodiments, no response is necessary and the ride may be immediately accepted. An indicator, flag, and/or other information may be passed back to the dynamic transportation matching system to assure the system that the provider computing device received the request.

The ride matching module 533 may receive the ride response, evaluate whether the provider accepted or declined the request, and may either find additional available providers for the request (if declined) or determine the ride request has been accepted and send matched ride information to the requestor computing device 520 and the provider computing device 550. The matched ride information may include provider information, requestor information, the pick-up location, the current location of the provider computing device, the current location of the requestor computing device, an estimated time of arrival for the provider, and/or any other suitable information to allow the requestor and the provider to complete the requested service. The ride matching module 533 may update the historical ride data store 536C with the corresponding matched ride information for the matched ride. Accordingly, the ride matching module may perform more efficient and effective matching of requests with providers.

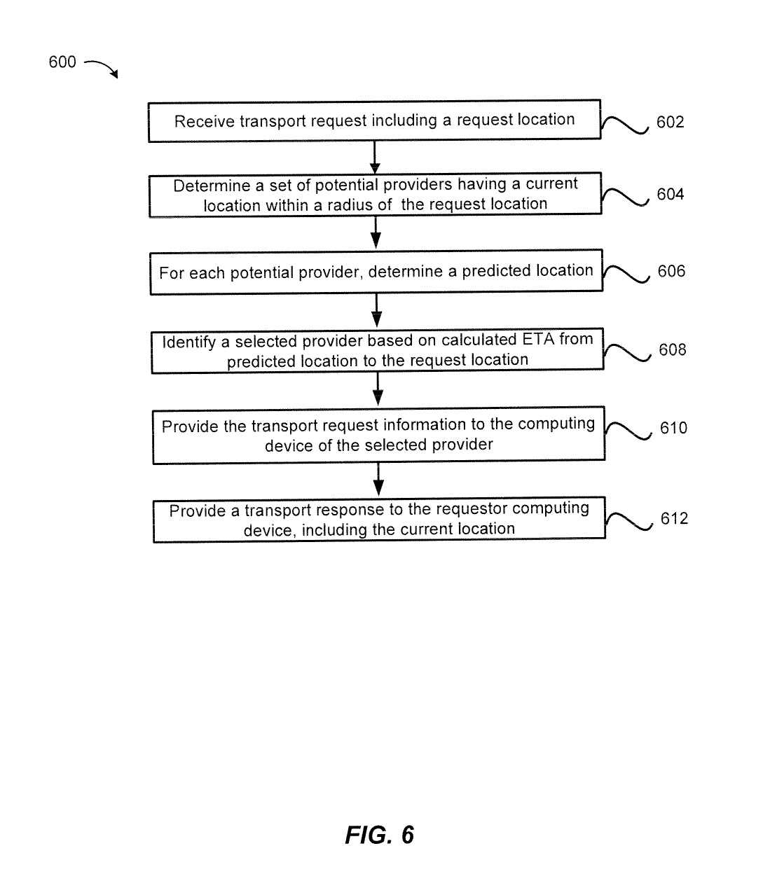

FIG. 6 illustrates an exemplary flow diagram 600 of a method for matching a provider with a requestor using projected locations for the provider, in accordance with an embodiment of the present techniques. Although this figure may depict functional operations in a particular sequence, the processes are not necessarily limited to the particular order or operations illustrated. One skilled in the art will appreciate that the various operations portrayed in this or other figures can be changed, rearranged, performed in parallel or adapted in various ways. Furthermore, it is to be understood that certain operations or sequences of operations can be added to or omitted from the process, without departing from the scope of the various embodiments. In addition, the process illustrations contained herein are intended to demonstrate an idea of the process flow to one of ordinary skill in the art, rather than specifying the actual sequences of code execution, which may be implemented as different flows or sequences, optimized for performance, or otherwise modified in various ways.

At step 602, the dynamic transportation matching system receives a transport request from a requestor computing device. The transport request may include a request location (i.e., pick-up location) for the transport request that corresponds to GPS or other location data of the requestor computing device, a request time, a requestor identifier, a requestor computing device location, and/or any other relevant information associated with the ride request and/or requestor. In some embodiments, the transport request may also include other requestor-specification requirements or preferences, for example, a request for a luxury vehicle, a number of passengers, a car seat, a car suitable for luggage, providers with a minimum rating, etc.

At step 604, a set of potential available providers is determined based on the current locations of the potential providers and information in the transport request. For example, out of a plurality of available providers, the dynamic transportation matching system may select a set of providers whose current locations are within a radius of the request location, or within a distance threshold from the request location. For example, the set of potential providers may be all within two miles of the request location. In some embodiments, the distance or radius may be converted into a time to travel threshold, for example the set of providers may be all within five minutes of travel time to the request location. The dynamic transportation matching system may also filter out providers that do not satisfy requestor-specified requirements or preferences. For example, if the requestor needs a provider with a vehicle that can carry six passengers, the dynamic transportation matching system will only include large vehicles in the set of potential available providers and will not include compact cars.

At step 606, for each potential provider, one or more projected locations may be determined and a corresponding confidence score for each projected location. The projected locations may be determined by evaluating environmental parameters, such as mapping data, construction detours, directions of roads, speed limits, traffic lights, traffic signs, etc. Environmental data can also include weather, road conditions, road directions, current traffic flow, a detected accident, a blocked road or lane, construction detours, a number of lanes on a road traveled by the provider, or a number of vehicles detected on the road traveled by the provider. Projected locations indicate a location of where the provider is predicted to travel to in a time period in the future. In some embodiments, the time period may account for delays in request processing and matching, delays in communications between the requestor computing device, dynamic transportation matching system, and the provider computing device. The confidence score for each projected location may be based on environmental data, statistical probabilities and/or prior transport data, and can be a quantitative measurement of a reliability of the probability the vehicle will travel to the projected location. The confidence score can serve to indicate to the dynamic transportation matching system that the projected location is trustworthy and can be relied upon for matching providers and requestors. The statistical probabilities may be calculated based on historical traffic patterns over a period of time in that geographic region. Prior transport data can include prior request locations, prior projected locations and their corresponding actual paths/locations, prior provider behavior, prior weather data, etc. and may be used to provide more customization and specificity to the statistical probabilities in determining a confidence score specific to the projected location and the provider. The projected location can further be determined based on real-time data, such as kinematic data of the provider, including the current speed, acceleration, and/or lane position of the provider vehicle. Other parameters that may be considered in determining a confidence score for the projected location can include historical projected locations from the current locations, directional information, timing delay to and from the requestor computing device, timing delay to and from the provider computing device, movement of the requestor, and historical data associated with the one or more providers.

At step 608, a selected provider from the set of potential providers may be identified as the selected provider to fulfill the request at the request location based on an ETA calculated from the projected location to the request location. After a confidence score of each projected location for each provider in the set of potential providers has been calculated, the dynamic transportation matching system may select the projected locations whose confidence scores are above a confidence threshold, or the highest confidence scores (e.g., top five highest confidence scores). The dynamic transportation matching system may then calculate an ETA for each of the confident project locations. The ETA can be an estimate of the time the provider vehicle will take to travel from the projected location to the request location. The selected provider may then be identified based on the projected location with the best ETA; in other words, the provider with the projected location who is estimated to arrive at the request location earliest, or within a time threshold (e.g., can arrive to the request location within three minutes).

At step 610, in an embodiment, after the selected provider has been identified, the dynamic transportation matching system may provide the transport request information to the selected provider's computing device. The transport request information may include the request location, target pickup location, and/or may be modified to include routing directions such that the provider can travel to the request location or target pickup location to fulfill the transport request. The transport request location may also include identifying information for the requestor so that the provider can locate the requestor at the request location.

At step 612, the dynamic transportation matching system may provide transport response to the requestor computing device. The transport response may include the current location of the provider computing device that is updated in real-time so that the requestor can track the provider vehicle as it is approaching the request location or target pickup location. The transport response transmitted to the requestor computing device may also include the ETA for the provider to arrive at the request location. In some embodiments, the transport request location may also include identifying information for the provider, so that the requestor can identify and locate the provider when the provider arrives at the request location.

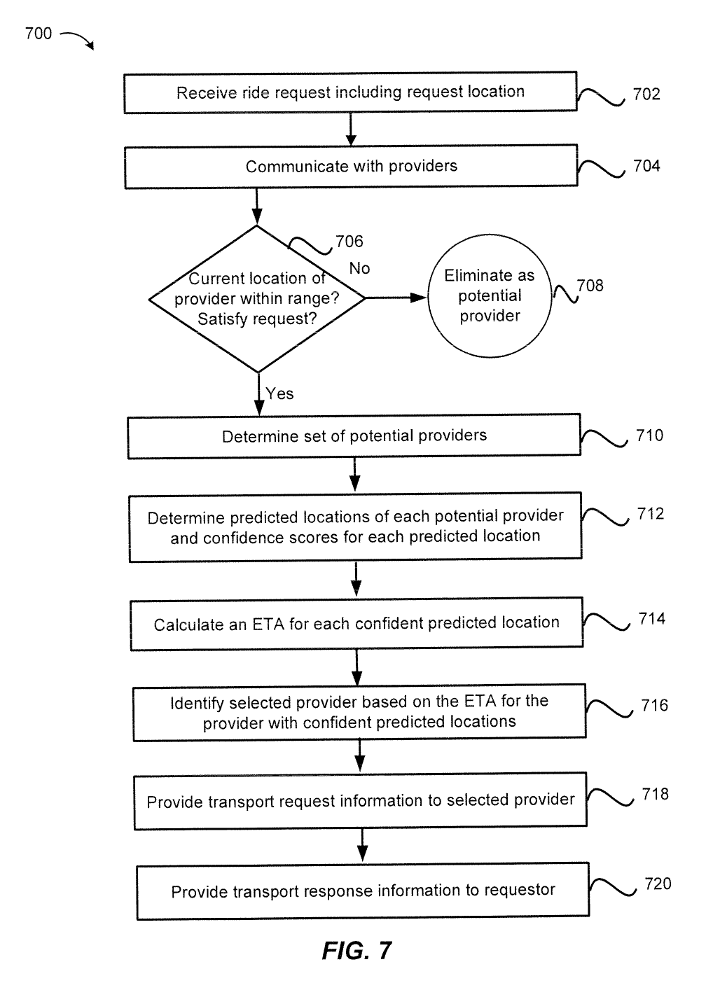

FIG. 7 illustrates an exemplary flow diagram 700 of a method for matching a provider with a requestor using confidence scores for projected locations for the provider and a matching score for the provider, in accordance with an embodiment of the present techniques.

At step 702, the dynamic transportation matching system receives a transport request from a requestor computing device. The transport request may include a request location (i.e., pick-up location) for the transport request that corresponds to GPS or other location data of the requestor computing device, a request location, a request time, a requestor identifier, a requestor computing device location, and/or any other relevant information associated with the transport request and/or requestor.

At step 704, the dynamic transportation matching system may communicate with a plurality of providers and their corresponding fleet of provider vehicles and/or provider computing devices. The provider computing devices may be pinged to poll their current location that corresponding to GPS or other location of the provider computing device and/or provide vehicle. In some embodiments, the current location may be received from a provider computing device, indicating the current location of the provider computing device, which is presumably the location of the provider or provider vehicle. In other embodiments, the current location may be received from a provider vehicle with embedded location technology, which may be more accurate, as a provider, with their provider computing device, may leave the vehicle and/or inadvertently forget to disable their provider computing device from communicating with the dynamic transportation matching system to process matches for transport requests. In an embodiment, the dynamic transportation matching system may not communicate with the full fleet of provider vehicles or providers, but a specific plurality of providers within a geographic region, such as within a city or zip code of the request location. For example, in response to a transport request and after determining a request location from the transport request, the dynamic transportation system may determine the city of the request location and communicate with the provider computing devices that are detected or scheduled to be operating within the city.

At step 706, after communicating with available providers, it may be determined with more specificity whether the current location of each provider of the plurality of providers is within a more narrow range of the request location. The range may be a predetermined distance threshold from the request location or a radius from the request location. For example, the dynamic transportation matching system may determine whether the provider is within three miles of the request location. In some embodiments, the distance threshold may be converted into a time threshold. For example, the dynamic transportation system may determine whether the provider is within five minutes of travel time to the request location. In some embodiments, the dynamic transportation matching system may also determine whether the potential providers satisfy the requirements in the request at 706.

If the current location of the provider in not within the distance range or time to travel range, then in 708 the provider is eliminated as a potential provider. If the current location of the provider is within the distance range or time to travel range, then in 710 it is added to a set of potential providers to fulfill the transport request. As such, the set of potential providers is a subset of the plurality of providers with whom the dynamic transportation matching system communicated with in 704. Each provider in the set of potential providers is determined to have a current location that is within a specified time or distance threshold range from the request location that makes each provider as a potential match to fulfill the transport request. In some embodiments at 708 the dynamic transportation matching system may eliminate providers that do not satisfy requestor-specified requirements or preferences, such as luxury vehicles, vehicles capable of a specific number of passengers, a type of vehicle, or a rating of a provider. Providers that satisfy the transport request requirements may be added to the set of potential providers in 710.

At step 712, the dynamic transportation matching system may then determine, for each provider in the set of potential providers, at least one projected location. The projected locations may be determined by evaluating environmental parameters, such as mapping data, construction detours, a number of lanes in a road, or directions of roads (e.g., one-way streets) to determine possible avenues where the provider can be projected to travel to in a time period in the future. The time period may be determined based on delays in request processing and matching, delays in communications between the requestor computing device, dynamic transportation matching system, and the provider computing device. For each projected location of each provider, a confidence score may be determined. For each projected location, a confidence score may be calculated, where the confidence score can be a quantitative measurement of a reliability of the probability the vehicle will travel to the projected location. The confidence score can serve to indicate to the dynamic transportation matching system that the projected location is trustworthy and can be relied upon for matching providers and requestors. The confidence score for each projected location may be based at least on statistical probabilities and/or prior transport data. For example, the statistical probabilities may be calculated based on historical traffic patterns over a period of time in the geographic region (e.g., city or zip code of the request location), or in the distance threshold (e.g., within three miles of the request location). Examples of prior transport data can include prior request locations, prior projected locations and their corresponding actual paths, prior provider behavior, prior weather data, etc. The prior transport data may be used, either additionally or alternatively to the statistical probabilities, to determine a confidence score specific to the projected location and the provider. The confidence score can be determined based on real-time data, such as kinematic data of the provider, including the current speed, acceleration, and/or lane position of the provider vehicle. In some embodiments, projected locations may be selected based on their confidence scores meeting a confidence threshold.

At step 714, for each confident projected location, an ETA may be calculated. Confident projected locations may be selected based on the confidence score associated with the projected location as meeting a confidence threshold, or as having the highest confidence scores (e.g., top three projected locations with the highest confidence scores). Each ETA may be the time that it is estimated the provider vehicle will take to travel from the respective projected location to the request location. The ETA calculation may be based on road distance, speed limit (e.g., school zone of 25 mph), current speed and acceleration of the provider vehicle, real-time traffic conditions (e.g., deadlocked rush hour traffic or low volume traffic), directions of the roads (e.g., one-way streets), number of turns and directions of turns (e.g., right turns being generally faster to make than left turns), construction zones and detours, accidents, etc.

At step 716, once the projected locations that are determined to be confident based on their respective confidence score and their respective ETAs calculated, the providers corresponding to the selected projected locations having the best ETAs (e.g., quickest) may be identified. The selected provider may be identified based on the projected location with the shortest ETA; in other words, the provider with the projected location who is estimated to arrive at the request location earliest, or within a time threshold (e.g., can arrive to the request location within three minutes). In some embodiments, the identified providers with confident projected locations may be evaluated to determine a matching score for each provider. A matching score may be determined based on the ETAs from the provider's projected locations, the provider's current location, the request location, ratings for the requestor and/or the provider, or demand within a geographic region. In some embodiments the matching score is separate from the confidence score and various factors used to calculate the matching score may be given different weights to ultimately determine which provider to select for matching with the request.

At step 718, after identifying the selected provider, the transport request information, including the request location or target pickup location, is sent to the provider computing device. In an embodiment, the provider computing device may also receive routing information to direct the provider to the request location. In various embodiments, the provider computing device may also transmit its actual current location again to update the dynamic transportation matching system on its current location after a time period in the future. This information can then be used to determine how accurate the projected location was, and provide feedback to the dynamic transportation matching system in improving its projected location model. The transport request location may also include identifying information for the requestor so that the provider can locate the requestor at the request location.

At step 720, transport response information may be transmitted to the requestor computing device. The transport response information may include, for example, the current location of the provider computing device, the ETA to the request location, and/or provider vehicle to provide a status to the requestor. The transport response information may also include a rating for the provider, identifying information associated with the provider (e.g., name, photo) and/or the provider vehicle (e.g., license plate, make and model of vehicle, color of vehicle). In an embodiment, the transport response information may also include information associated with a provider communication device with a display that can be easily detected for the requestor to identify their matched provider.

In various embodiments, the dynamic transportation matching system may apply a projected location model to determine projected locations for each provider in the set of potential providers. The projected location model may be created based on a demand-based approach that simulates how providers may travel during time when they are not matched with a requestor, how providers may preemptively travel towards areas that historically have high demand (e.g., moving towards a financial district during rush hour time of day between 5-7 pm), and/or how providers travel during their private time (e.g., driving to where they live at the end of the work day, and thus can be matched with requests going in that direction). The projected location model may be based on the Markov property such that it does not rely on historical data but is based on the current state, and the presumption that provider will navigate and gravitate towards areas of high demand, regardless of their prior state. The projected location model may also account for time lags and delays associated with decision making associated with both providers and requestors, driving delays associated with providers, and/or uncertainty associated with determining where requestors will be and how providers can follow routing directions. Predicted travel vectors for the providers may be determined to simulate provider behavior. This may include monitoring provider behavior to determine the accuracy of projected locations. For example, the projected location model may compare previous projected locations with their corresponding previous actual locations and determine accuracy values based on whether the previous actual locations match the previous projected locations. For example, whether the provider vehicle actually ended up at the projected location after a period of time, or ended up close to the projected location.

In another embodiment, the dynamic transportation matching system may generate and implement a hybrid projected location model to determine projected locations for each provider. For short term predictions (e.g., several seconds), the hybrid model may use kinematic data of the vehicle to determine potential projected locations, but then for longer term predictions (e.g., a minute or more), the hybrid model may apply the projected locations model described above. In some embodiments, the dynamic transportation system may monitor and use projected locations of providers in the short term and long term for various applications, for example, in making dispatch and matching decisions, for ETA estimations, and for other location services, such as predicting and managing future demand. The hybrid model may determine a first short term projected location (e.g., where the provider vehicle will be in five seconds) and then determine a second longer term projected location (e.g., where the provider vehicle will be in thirty seconds to a minute).

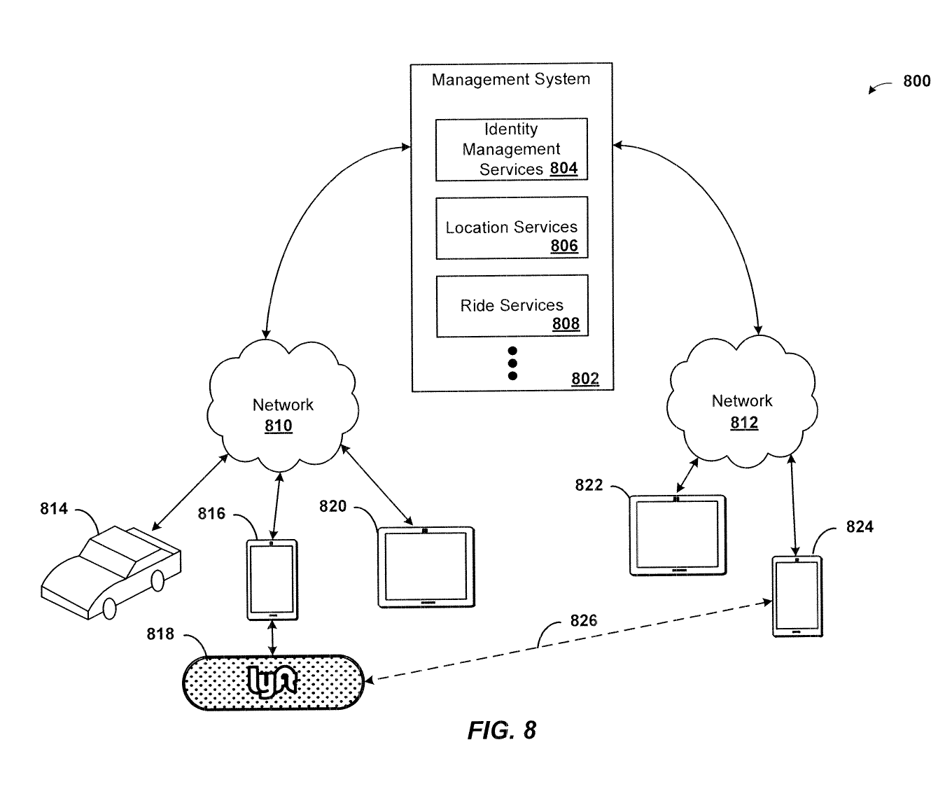

FIG. 8 shows a requestor/provider management environment 800, in accordance with various embodiments. As shown in FIG. 8, a management system 802 can be configured to provide various services to requestor and provider devices. Management system 802 can run one or more services or software applications, including identity management services 804, location services 806, ride services 808, or other services. Although three services are shown as being provided by management system 802, more or fewer services may be provided in various implementations. In various embodiments, management system 802 may include one or more general purpose computers, server computers, clustered computing systems, cloud-based computing systems, or any other computing systems or arrangements of computing systems. Management system 802 may be configured to run any or all of the services and/or software applications described with respect to various embodiments of the present techniques described herein. In some embodiments, management system 802 can run any appropriate operating system as well as various server applications, such as common gateway interface (CGI) servers, JAVA® servers, hypertext transport protocol (HTTP) servers, file transfer protocol (FTP) servers, database servers, etc.

Identity management services 804 may include various identity services, such as access management and authorization services for requestors and providers when interacting with management system 802. This may include, e.g., authenticating the identity of providers and determining that the providers are authorized to provide services through management system 802. Similarly, requestors' identities may be authenticated to determine whether the requestor is authorized to receive the requested services through management system 802. Identity management services 804 may also control access to provider and requestor data maintained by management system 802, such as driving and/or ride histories, personal data, or other user data. Location services 806 may include navigation and/or traffic management services and user interfaces, or other location services.

In various embodiments, ride services 808 may include ride matching and management services to connect a requestor to a provider. Ride services 808 may include a user interface and or may receive data from requestors and providers through applications executing on their respective devices. Ride services 808 may, e.g., confirm the identity of requestors and providers using identity management services 804, and determine that each user is authorized for the requested ride service. In some embodiments, ride services 808 can identify an appropriate provider using a location obtained from a requestor and location services 806 to identify, e.g., a closest provider. As such, ride services 808 can manage the distribution and allocation of provider and requestor resources, consistent with embodiments described herein.

Management system 802 can connect to various devices through network 810 and 812. Networks 810, 812 can include any network configured to send and/or receive data communications using various communication protocols, such as AppleTalk, transmission control protocol/Internet protocol (TCP/IP), Internet packet exchange (IPX), systems network architecture (SNA), etc. In some embodiments, networks 810, 812 can include local area networks (LAN), such as Ethernet, Token-Ring or other LANs. Networks 810, 812 can include a wide-area network and/or the Internet. In some embodiments, networks 810, 812 can include VPNs (virtual private networks), PSTNs (a public switched telephone networks), infra-red networks, or any wireless network, including networks implementing the IEEE 802.11 family of standards, Bluetooth®, Bluetooth® Low Energy, NFC and/or any other wireless protocol. In various embodiments, networks 810, 812 can include a mobile network, such as a mobile telephone network, cellular network, satellite network, or other mobile network. Networks 810, 812 may be the same as communication network 170 in FIG. 1. In some embodiments, networks 810, 812 may each include a combination of networks described herein or other networks as are known to one of ordinary skill in the art.

Users may then utilize one or more services provided by management system 802 using applications executing on provider and requestor devices. As shown in FIG. 8, provider computing devices 814, 816, 818, and/or 820 may include mobile devices (e.g., an iPhone an iPad®, mobile telephone, tablet computer, a personal digital assistant (PDA)), wearable devices (e.g., head mounted displays, etc.), thin client devices, gaming consoles, or other devices configured to communicate over one or more networks 810, 812. Each provider or requestor device can execute various operating systems (e.g., Android, iOS, etc.) and configured to communicate over the Internet, Blackberry® messenger, short message service (SMS), email, and various other messaging applications and/or communication protocols. The requestor and provider computing devices can include general purpose computers (e.g., personal computers, laptop computers, or other computing devices executing operating systems such as macOS®, Windows®, Linux®, various UNIX® or UNIX- or Linux-based operating systems, or other operating systems). In some embodiments, provider computing device 814 can include a vehicle-integrated computing device, such as a vehicle navigation system, or other computing device integrated with the vehicle itself.

In some embodiments, provider computing device 818 can include a provider communication device configured to communicate with users, such as providers, passengers, pedestrians, and other users. In some embodiments, provider communication device 818 can communicate directly with management system 802 or through another provider computing device, such as provider computing device 816. In some embodiments, a requestor computing device can communicate 826 directly with provider communication device 818 over a peer-to-peer connection, Bluetooth connection, NFC connection, ad hoc wireless network, or any other communication channel or connection. Although particular devices are shown as communicating with management system 802 over networks 810 and 812, in various embodiments, management system 802 can expose an interface, such as an application programming interface (API) or service provider interface (SPI) to enable various third parties which may serve as an intermediary between end users and management system 802.

Although requestor/provider management environment 800 is shown with four provider devices and two requestor devices, any number of devices may be supported. The various components shown and described herein may be implemented in hardware, firmware, software, or combinations thereof. Although one embodiment of a requestor/provider management environment is depicted in FIG. 8, this is merely one implementation and not meant to be limiting.

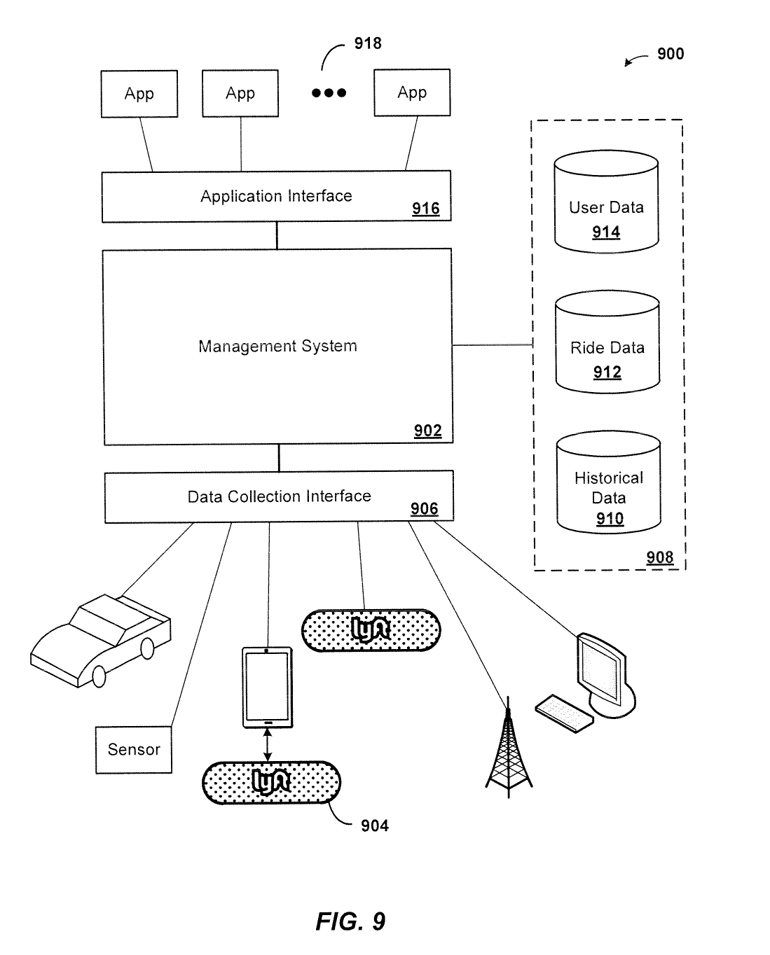

FIG. 9 shows a data collection and application management environment 900, in accordance with various embodiments. As shown in FIG. 9, management system 902 may be configured to collect data from various data collection devices 904 through a data collection interface 906. As discussed above, management system 902 may include one or more computers and/or servers or any combination thereof. Data collection devices 904 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 906 can include, e.g., an extensible device framework configured to support interfaces for each data collection device. In various embodiments, data collection interface 906 can be extended to support new data collection devices as they are released and/or to update existing interfaces to support changes to existing data collection devices. In various embodiments, data collection devices may communicate with data collection interface 906 over one or more networks. The networks may include any network or communication protocol as would be recognized by one of ordinary skill in the art, including those networks discussed above.

As shown in FIG. 9, data received from data collection devices 904 can be stored in data store 908. Data store 908 can include one or more data stores, such as databases, object storage systems and services, cloud-based storage services, and other data stores. For example, various data stores may be implemented on a non-transitory storage medium accessible to management system 902, such as historical data store 910, ride data store 912, and user data store 914. Data stores 908 can be local to management system 902, or remote and accessible over a network, such as those networks discussed above or a storage-area network or other networked storage system. In various embodiments, historical data 910 may include historical traffic data, weather data, request data, road condition data, or any other data for a given region or regions received from various data collection devices. Ride data 912 may include route data, request data, timing data, and other ride related data, in aggregate and/or by requestor or provider. User data 914 may include user account data, preferences, location history, and other user-specific data. Although particular data stores are shown, any data collected and/or stored according to the various embodiments described herein may be stored in data stores 908.

As shown in FIG. 9, an application interface 916 can be provided by management system 902 to enable various apps 918 to access data and/or services available through management system 902. Apps 918 can run on various user devices (including provider and requestor computing devices, such as those discussed above) and/or may include cloud-based or other distributed apps configured to run across various devices (e.g., computers, servers, or combinations thereof). Apps 918 may include, e.g., aggregation and/or reporting apps which may utilize data 908 to provide various services (e.g., third-party ride request and management apps). In various embodiments, application interface 916 can include an API and/or SPI enabling third party development of apps 918. In some embodiments, application interface 916 may include a web interface, enabling web-based access to data 908 and/or services provided by management system 902. In various embodiments, apps 918 may run on devices configured to communicate with application interface 916 over one or more networks. The networks may include any network or communication protocol as would be recognized by one of ordinary skill in the art, including those networks discussed above, in accordance with an embodiment of the present disclosure.

Although a particular implementation of environment 900 is shown in FIG. 9, this is for illustration purposes only and not intended to be limited. In some embodiments, environment 900 may include fewer or more components, as would be recognized by one or ordinary skill in the art.

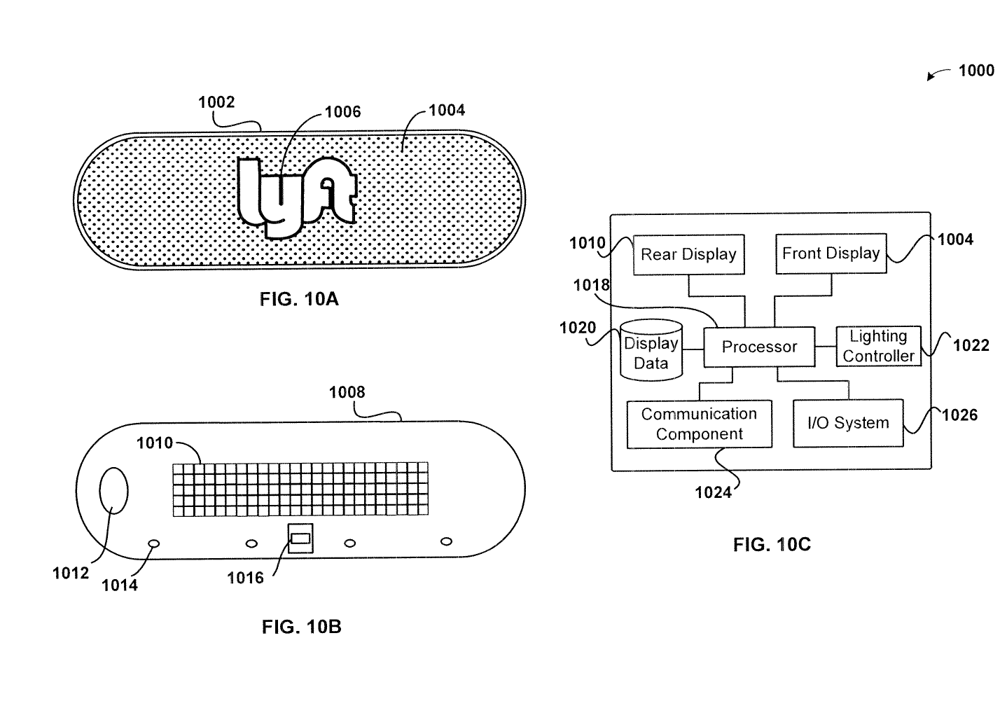

FIGS. 10A-10C show an example provider communication device 1000 in accordance with various embodiments. As shown in FIG. 10A, a front view 1002 of provider communication device 1000 shows a front display 1004. In some embodiments, front display 1004 may include a secondary region or separate display 1006. As shown in FIG. 10A, the front display may include various display technologies including, but not limited to, one or more liquid crystal displays (LCDs), one or more arrays of light emitting diodes (LEDs), or other display technologies. In some embodiments, the front display may include a cover that divides the display into multiple regions. In some embodiments, separate displays may be associated with each region. The front display 1004 can be configured to show colors, patterns, color patterns, or other identifying information to requestors and other users external to a provider vehicle. In some embodiments, the secondary region or separate display 1006 may be configured to display the same, or contrasting, information as front display 1004.

As shown in FIG. 10B, a rear view 1008 of provider communication device 1000 shows a rear display 1010. Rear display 1010, as with front display 1004, rear display 1010 may include various display technologies including, but not limited to, one or more liquid crystal displays (LCDs), one or more arrays of light emitting diodes (LEDs), or other display technologies. The rear display may be configured to display information to the provider, the requestor, or other users internal to a provider vehicle. In some embodiments, rear display 1010 may be configured to provide information to users external to the provider vehicle who are located behind the provider vehicle. As further shown in FIG. 10B, provider communication device may include a power button 1012 or other switch which can be used to turn on or off the provider communication device. In various embodiments, power button 1012 may be a hardware button or switch that physically controls whether power is provided to provider communication device 1000. Alternatively, power button 1012 may be a soft button that initiates a startup/shutdown procedure managed by software and/or firmware instructions. In some embodiments, provider communication device 1000 may not include a power button 1012. Additionally, provider communication device may include one or more light features 1014 (such as one or more LEDs or other light sources) configured to illuminate areas adjacent to the provider communication device 1000. In some embodiments, provider communication device 1000 can include a connector to enable a provider computing device to be connected to the provider communication device 1000. In some embodiments, power may be provided to the provider communication device through connector 1016.

FIG. 10C shows a block diagram of provider computing device 1000. As shown in FIG. 10C, provider communication device can include a processor 1018. Processor 1018 can control information displayed on rear display 1010 and front display 1004. As noted, each display can display information to different users, depending on the positioning of the users and the provider communication device. In some embodiments, display data 1020 can include stored display patterns, sequences, colors, text, or other data to be displayed on the front and/or rear display. In some embodiments, display data 1020 can be a buffer, storing display data as it is received from a connected provider computing device. In some embodiments, display data 1020 can include a hard disk drive, solid state drive, memory, or other storage device including information from a management system. In some embodiments, lighting controller 1022 can manage the colors and/or other lighting displayed by light features 1014. In some embodiments, communication component 1024 can manage networking or other communication between the provider communication device 1000 and one or more networking components or other computing devices. In various embodiments, communication component 1024 can be configured to communicate over Wi-Fi, Bluetooth, NFC, RF, or any other wired or wireless communication network or protocol. In some embodiments, provider communication device 1000 can include an input/output system 1026 configured to provide output in addition to that provided through the displays and/or to receive inputs from users. For example, I/O system 1026 can include an image capture device configured to recognize motion or gesture-based inputs from a user. Additionally, or alternatively. I/O system 1026 can include an audio device configured to provide audio outputs (such as alerts, instructions, or other information) to users and/or receive audio inputs, such as audio commands, which may be interpreted by a voice recognition system or other command interface. In some embodiments, I/O system may include one or more input or output ports, such as USB (universal serial bus) ports, lightning connector ports, or other ports enabling users to directly connect their devices to the provider communication device (e.g., to exchange data, verify identity information, provide power, etc.).

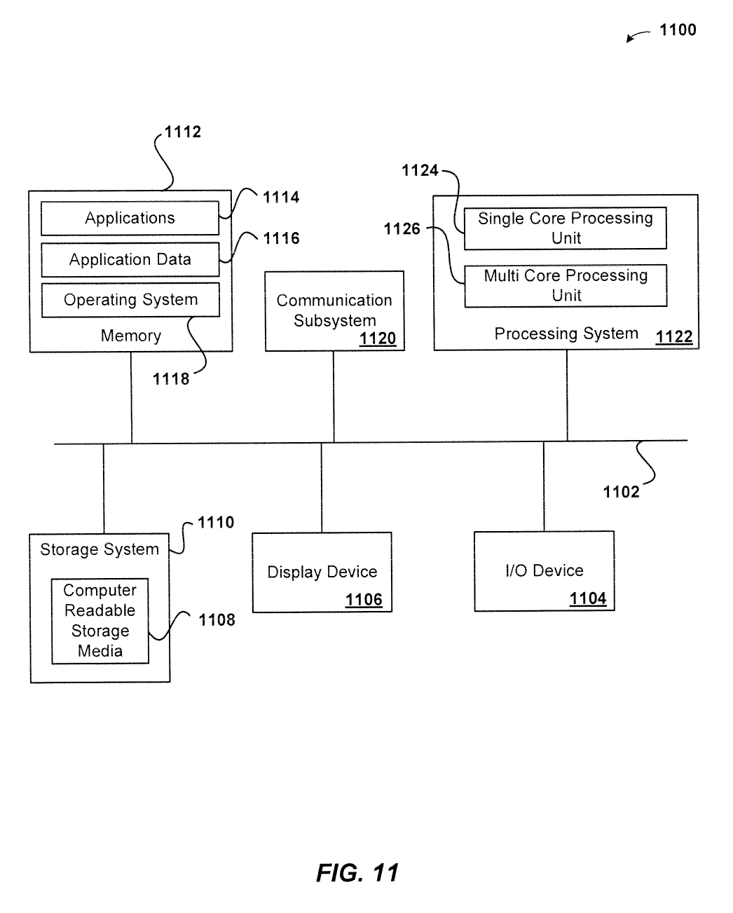

FIG. 11 shows an example computer system 1100, in accordance with various embodiments. In various embodiments, computer system 1100 may be used to implement any of the systems, devices, or methods described herein. In some embodiments, computer system 1100 may correspond to any of the various devices described herein, including, but not limited, to mobile devices, tablet computing devices, wearable devices, personal or laptop computers, vehicle-based computing devices, or other devices or systems described herein. As shown in FIG. 11, computer system 1100 can include various subsystems connected by a bus 1102. The subsystems may include an I/O device subsystem 1104, a display device subsystem 1106, and a storage subsystem 1110 including one or more computer readable storage media 1108. The subsystems may also include a memory subsystem 1112, a communication subsystem 1120, and a processing subsystem 1122.

In system 1100, bus 1102 facilitates communication between the various subsystems. Although a single bus 1102 is shown, alternative bus configurations may also be used. Bus 1102 may include any bus or other component to facilitate such communication as is known to one of ordinary skill in the art. Examples of such bus systems may include a local bus, parallel bus, serial bus, bus network, and/or multiple bus systems coordinated by a bus controller. Bus 1102 may include one or more buses implementing various standards such as Parallel ATA, serial ATA, Industry Standard Architecture (ISA) bus, Extended ISA (EISA) bus, MicroChannel Architecture (MCA) bus, Peripheral Component Interconnect (PCI) bus, or any other architecture or standard as is known in the art.

In some embodiments, I/O device subsystem 1104 may include various input and/or output devices or interfaces for communicating with such devices. Such devices may include, without limitation, a touch screen or other touch-sensitive input device, a keyboard, a mouse, a trackball, a motion sensor or other movement-based gesture recognition device, a scroll wheel, a click wheel, a dial, a button, a switch, audio recognition devices configured to receive voice commands, microphones, image capture based devices such as eye activity monitors configured to recognize commands based on eye movement or blinking, and other types of input devices. I/O device subsystem 1104 may also include identification or authentication devices, such as fingerprint scanners, voiceprint scanners, iris scanners, or other biometric sensors or detectors. In various embodiments, I/O device subsystem may include audio output devices, such as speakers, media players, or other output devices.

Computer system 1100 may include a display device subsystem 1106. Display device subsystem may include one or more lights, such as an one or more light emitting diodes (LEDs), LED arrays, a liquid crystal display (LCD) or plasma display or other flat-screen display, a touch screen, a head-mounted display or other wearable display device, a projection device, a cathode ray tube (CRT), and any other display technology configured to visually convey information. In various embodiments, display device subsystem 1106 may include a controller and/or interface for controlling and/or communicating with an external display, such as any of the above-mentioned display technologies.

As shown in FIG. 11, system 1100 may include storage subsystem 1110 including various computer readable storage media 1108, such as hard disk drives, solid state drives (including RAM-based and/or flash-based SSDs), or other storage devices. In various embodiments, computer readable storage media 1108 can be configured to store software, including programs, code, or other instructions, that is executable by a processor to provide functionality described herein. In some embodiments, storage system 1110 may include various data stores or repositories or interface with various data stores or repositories that store data used with embodiments described herein. Such data stores may include, databases, object storage systems and services, data lakes or other data warehouse services or systems, distributed data stores, cloud-based storage systems and services, file systems, and any other data storage system or service. In some embodiments, storage system 1110 can include a media reader, card reader, or other storage interface to communicate with one or more external and/or removable storage devices. In various embodiments, computer readable storage media 1108 can include any appropriate storage medium or combination of storage media. For example, computer readable storage media 1108 can include, but is not limited to, any one or more of random access memory (RAM), read only memory (ROM), electronically erasable programmable ROM (EEPROM), flash memory or other memory technology, optical storage (e.g., CD-ROM, digital versatile disk (DVD), Blu-ray® disk or other optical storage device), magnetic storage (e.g., tape drives, cassettes, magnetic disk storage or other magnetic storage devices). In some embodiments, computer readable storage media can include data signals or any other medium through which data can be sent and/or received.

Memory subsystem 1112 can include various types of memory, including RAM, ROM, flash memory, or other memory. Memory 1112 can include SRAM (static RAM) or DRAM (dynamic RAM). In some embodiments, memory 1112 can include a BIOS (basic input/output system) or other firmware configured to manage initialization of various components during, e.g., startup. As shown in FIG. 11, memory 1112 can include applications 1114 and application data 1110. Applications 1114 may include programs, code, or other instructions, that can be executed by a processor. Applications 1114 can include various applications such as browser clients, location management applications, ride management applications, data management applications, and any other application. Application data 1116 can include any data produced and/or consumed by applications 1114. Memory 1112 can additionally include operating system 1118, such as macOS®, Windows®, Linux®, various UNIX® or UNIX- or Linux-based operating systems, or other operating systems.

System 1100 can also include a communication subsystem 1120 configured to facilitate communication between system 1100 and various external computer systems and/or networks (such as the Internet, a local area network (LAN), a wide area network (WAN), a mobile network, or any other network). Communication subsystem 1120 can include hardware and/or software to enable communication over various wired (such as Ethernet or other wired communication technology) or wireless communication channels, such as radio transceivers to facilitate communication over wireless networks, mobile or cellular voice and/or data networks, Wi-Fi networks, or other wireless communication networks. For example, the communication network is shown as communication network 170 in FIG. 1. Additionally, or alternatively, communication subsystem 1120 can include hardware and/or software components to communicate with satellite-based or ground-based location services, such as GPS (global positioning system). In some embodiments, communication subsystem 1120 may include, or interface with, various hardware or software sensors. The sensors may be configured to provide continuous or and/or periodic data or data streams to a computer system through communication subsystem 1120

As shown in FIG. 11, processing system 1122 can include one or more processors or other devices operable to control computing system 1100. Such processors can include single core processors 1124, multi core processors, which can include central processing units (CPUs), graphical processing units (GPUs), application specific integrated circuits (ASICs), digital signal processors (DSPs) or any other generalized or specialized microprocessor or integrated circuit. Various processors within processing system 1122, such as processors 1124 and 1126, may be used independently or in combination depending on application. Various other configurations are may also be used, with particular elements that are depicted as being implemented in hardware may instead be implemented in software, firmware, or a combination thereof. One of ordinary skill in the art will recognize various alternatives to the specific embodiments described herein.

The specification and figures describe particular embodiments which are provided for ease of description and illustration and are not intended to be restrictive. Embodiments may be implemented to be used in various environments without departing from the spirit and scope of the disclosure.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1-21. (canceled)

22. A method comprising:
receiving a transport request from a requestor computing device, the transport request associated with a request location;
identifying a first provider computing device and a second provider computing device based on the transport request;
determining a travel path for the first provider computing device by determining a probability of each available travel path for the first provider computing device using location data and kinematic data associated with the first provider computing device;
determining a travel path for the second provider computing device by determining a probability of each available travel path for the second provider computing device using location data and kinematic data corresponding to the second provider computing device; and
assigning the transport request to an optimal future location match between the first provider computing device and the second provider computing device by determining a first estimated time of arrival based on the travel path of the first provider computing device to the request location and by determining a second estimated time of arrival based on the travel path of the second provider computing device to the request location.

23. The method of claim 22, further comprising:
identifying a future location of the first provider computing device based on the travel path of the first provider computing device; and
identifying a future location of the second provider computing device based on the travel path of the second provider computing device, wherein:
determining the first estimated time of arrival based on the travel path of the first provider computing device comprises determining a travel time between the future location of the first provider computing device and the request location; and
determining the second estimated time of arrival based on the travel path of the second provider computing device comprises determining a travel time between the future location of the second provider computing device and the request location.

24. The method of claim 23, wherein identifying the future location of the first provider computing device comprises projecting a location of the first provider computing device along the travel path of the first provider computing device at a predetermined time in the future.

25. The method of claim 23, wherein assigning the transport request to the optimal future location match between the first provider computing device and the second provider computing device further comprises identifying the optimal future location match corresponds to the first provider computing device by determining the first estimated time of arrival based on the travel path of the first provider computing device is less than the second estimated time of arrival based on the travel path of the second provider computing device.

26. The method of claim 25, further comprising:
sending transport assignment information associated with the transport request to the first computing device based on identifying the optimal future location match corresponds to the first provider computing device; and
sending transport response information associated with the transport request to the requestor computing device, the transport response information comprising the estimated time of arrival from the future location of the first provider computing device to the request location.

27. The method of claim 22, wherein determining the probability of each available travel path for the first provider computing device is further based on historical route decisions associated with the first provider computer device.

28. The method of claim 27, wherein the historical route decisions associated with the first provider computing device correspond to the available travel paths for the first provider computing device.

29. The method of claim 22, wherein determining the probability of each available travel path for the first provider computing device is further based on a road lane position of the first provider computer device.

30. The method of claim 22, further comprising:
accessing environmental data corresponding to a location of the first provider computing device, wherein the environmental data includes at least one of weather, road conditions, road directions, traffic flow, a detected accident, a blocked road or lane, construction detours, a number of lanes on a road, or a number of vehicles detected on a road; and
wherein determining the probability of each available travel path for the first provider computing device is further based on the environmental data corresponding to the location of the first provider computer device.

31. A non-transitory computer readable medium storing instructions that, when executed by at least one processor, cause a computer system to:
receive a transport request from a requestor computing device, the transport request associated with a request location;
identify a first provider computing device and a second provider computing device based on the transport request;
determine a travel path for the first provider computing device by determining a probability of each available travel path for the first provider computing device using location data and kinematic data associated with the first provider computing device;
determine a travel path for the second provider computing device by determining a probability of each available travel path for the second provider computing device using location data and kinematic data associated with the second provider computing device; and
assign the transport request to an optimal future location match between the first provider computing device and the second provider computing device by determining a first estimated time of arrival based on the travel path of the first provider computing device to the request location and by determining a second estimated time of arrival based on the travel path of the second provider computing device to the request location.

32. The non-transitory computer readable medium of claim 31, further comprising instructions that, when executed by the at least one processor, cause the computer system to:
identify a future location of the first provider computing device based on the travel path of the first provider computing device; and
wherein determining the first estimated time of arrival based on the travel path of the first provider computing device comprises determining a travel time between the future location of the first provider computing device and the request location.

33. The non-transitory computer readable medium of claim 32, wherein identifying the future location of the first provider computing device comprises projecting a location of the first provider computing device along the travel path of the first provider computing device at a predetermined time in the future.

34. The non-transitory computer readable medium of claim 31, wherein assigning the transport request to the optimal future location match between the first provider computing device and the second provider computing device further comprises identifying the optimal future location match corresponds to the first provider computing device by determining the first estimated time of arrival based on the travel path of the first provider computing device is less than the second estimated time of arrival based on the travel path of the second provider computing device.

35. The non-transitory computer readable medium of claim 31, wherein determining the probability of each available travel path for the first provider computing device is further based on historical route decisions for the first provider computer device.

36. The non-transitory computer readable medium of claim 31, wherein determining the probability of each available travel path for the first provider computing device is further based on a road lane position for the first provider computer device.

37. The non-transitory computer readable medium of claim 31, further comprising instructions that, when executed by the at least one processor, cause the computer system to:
access environmental data corresponding to a location of the first provider computing device, wherein the environmental data includes at least one of weather, road conditions, road directions, traffic flow, a detected accident, a blocked road or lane, construction detours, a number of lanes on a road, or a number of vehicles detected on a road; and
wherein determining the probability of each available travel path for the first provider computing device is further based on the environmental data corresponding to the location of the first provider computer device.

38. A system comprising:
at least one processor; and
at least one non-transitory computer readable storage medium storing instructions that, when executed by the at least one processor, cause the system to:
receive a transport request from a requestor computing device, the transport request associated with a request location;
identify a first provider computing device and a second provider computing device based on the transport request;
determine a travel path for the first provider computing device by determining a probability of each available travel path for the first provider computing device using location data and kinematic data associated with the first provider computing device;
determine a travel path for the second provider computing device by determining a probability of each available travel path for the second provider computing device using location data and kinematic data associated with the second provider computing device; and
assign the transport request to an optimal future location match between the first provider computing device and the second provider computing device by determining a first estimated time of arrival based on the travel path of the first provider computing device to the request location and by determining a second estimated time of arrival based on the travel path of the second provider computing device to the request location.

39. The system of claim 38, wherein assigning the transport request to the optimal future location match between the first provider computing device and the second provider computing device further comprises identifying the optimal future location match corresponds to the first provider computing device by determining the first estimated time of arrival based on the travel path of the first provider computing device is less than the second estimated time of arrival based on the travel path of the second provider computing device.

40. The system of claim 38, further comprising instructions that, when executed by the at least one processor, cause the system to:
identify a future location of the first provider computing device based on the travel path of the first provider computing device; and
identify a future location of the second provider computing device based on the travel path of the second provider computing device, wherein:
determining the first estimated time of arrival based on the travel path of the first provider computing device comprises determining a travel time between the future location of the first provider computing device and the request location; and
determining the second estimated time of arrival based on the travel path of the second provider computing device comprises determining a travel time between the future location of the second provider computing device and the request location.

41. The system of claim 40, wherein identifying the future location of the first provider computing device comprises projecting a location of the first provider computing device along the travel path of the first provider computing device at a predetermined time in the future.
